(19) United States
(12) Patent Application Publication
(10) Pub. No.: US 2022/0043458 A1
(43) Pub. Date: Feb. 10, 2022

(54) INFORMATION PROCESSING APPARATUS AND METHOD, PROGRAM, AND MOBILE BODY CONTROL SYSTEM

(71) Applicant: Sony Corporation, Tokyo (JP)

(72) Inventor: Chao Wang, Zhuhai, Guangdong (CN)

(73) Assignee: Sony Corporation, Tokyo (JP)

(21) Appl. No.: 17/279,026

(22) PCT Filed: Sep. 20, 2019
(86) PCT No.: PCT/JP2019/036898

§ 371 Date: Mar. 23, 2021

(30) Foreign Application Priority Data
Oct. 4, 2018 (JP) 2018-189312

(51) Int. Cl. G05D 1/02; G01C 21/32

(52) U.S. Cl. CPC G05D 1/0274; G01C 21/32; G05D 2201/0213; G05D 1/0278; G05D 1/027

(57) ABSTRACT

There is provided an information processing apparatus including a relative self-position estimation unit that obtains a first relative position of a mobile body with respect to a self-position identification origin that is a movement initiation position of the mobile body, and a map management unit that updates relative position relationship information indicating a second relative position of each of a plurality of coordinate origins with respect to a plurality of the self-position identification origin, wherein each of the plurality of coordinate origins is associated with a different predetermined coordinate system, on the basis of, for each coordinate origin of the plurality of coordinate origins: a relative position of the mobile body with respect to the coordinate origin and a relative position of the mobile body with respect to the self-position identification origins.

### TECHNICAL FIELD

The present technology relates to information processing apparatus and method, a program, and a mobile body control system, and particularly to, information processing apparatus and method, a program, and a mobile body control system which are capable of realizing smooth travelling over a plurality of maps.

### CROSS REFERENCE TO RELATED APPLICATIONS

This application claims the benefit of Japanese Priority Patent Application JP 2018-189312 filed Oct. 4, 2018, the entire contents of which are incorporated herein by reference.

### BACKGROUND ART

In the related art, an autonomous mobile system that estimates a self-position with reference to map data corresponding to an actual environment on the basis of data of a measurement device (sensor) mounted on a mobile body that moves indoors and outdoors, and moves along a planned travel route (refer to PTL 1).

In a map, various coordinate systems, and self-position estimation methods corresponding to the coordinate systems exist.

### CITATION LIST

### Patent Literature

PTL 1: International Publication No. 2013/150630

### SUMMARY OF INVENTION

### Technical Problem

In the related art, when desiring to simultaneously use maps in which coordinate systems are different from each other, since corresponding self-position estimation methods are different from each other, there is no mechanism that manages a different data structure, a relative position, and a state. Therefore, it is difficult to simultaneously use maps in which coordinate systems are different from each other.

The present technology has been made in consideration such circumstances, and an object thereof is to realize smooth travelling over a plurality of maps.

### Solution to Problem

According to a first aspect of the present technology, there is provided an information processing apparatus including: a processor in communication with a memory configured to store instructions that, when executed by the processor, cause the processor to: obtain a first relative position of a mobile body with respect to a self-position identification origin that is a movement initiation position of the mobile body; and update relative position relationship information indicating a second relative position of each of a plurality of coordinate origins with respect to the self-position identification origin, wherein each of the plurality of coordinate origins is associated with a different predetermined coordinate system, on a basis of, for each coordinate origin of the plurality of coordinate origins: a third relative position of the mobile body with respect to the coordinate origin; and the first relative position of the mobile body with respect to the self-position identification origin.

In the first aspect of the present technology, a first relative position of the mobile body with respect to a self-position identification origin that is a movement initiation position of the mobile body is obtained. In addition, relative position relationship information indicating a second relative position of each of a plurality of coordinate origins with respect to the self-position identification origin is updated, wherein each of the plurality of coordinate origins is associated with a different predetermined coordinate system, on the basis of, for each coordinate origin of the plurality of coordinate origins: a third relative position of the mobile body with respect to the coordinate origin; and the first relative position of the mobile body with respect to the self-position identification origins.

According to a second aspect of the present technology, there is provided a mobile body control system, comprising: an information processing apparatus including, a relative self-position estimation unit that obtains a first relative position of a mobile body with respect to a self-position identification origin that is a movement initiation position of the mobile body, and a map management unit that updates relative position relationship information indicating a second relative position of each of a plurality of coordinate origins with respect to the self-position identification origin, wherein each of the plurality of coordinate origins is associated with a different predetermined coordinate system, on a basis of, for each coordinate origin of the plurality of coordinate origins: a third relative position of the mobile body with respect to the coordinate origin; and the first relative position of the mobile body with respect to the self-position identification origin; and the mobile body including a movement control unit that controls movement by using a coordinate system that is expanded on a basis of the relative position relationship information.

In the second aspect of the present technology, a first relative position of a mobile body with respect to a self-position identification origin that is a movement initiation position of the mobile body is obtained by the information processing apparatus, and relative position relationship information indicating a second relative position of each of a plurality of coordinate origins with respect to the self-position identification origin is updated, wherein each of the plurality of coordinate origins is associated with a different predetermined coordinate system, on the basis of, for each coordinate origin of the plurality of coordinate origins: a third relative position of the mobile body with respect to the coordinate origin and the first relative position of the mobile body with respect to the self-position identification origins. In addition, movement is controlled by the mobile body by using a coordinate system that is expanded on the basis of the relative position relationship information.

### BRIEF DESCRIPTION OF DRAWINGS

FIG. 1 is a view illustrating an example of a movement route of a mobile apparatus on which an information processing device, to which the present technology is applied, is mounted.

FIG. 2 is a view illustrating an example of a relative position tree.

FIG. 3 is a view illustrating an example of a process using the relative position tree.

FIG. 4 is a view illustrating another example of the process using the relative position tree.

FIG. 5 is a view illustrating an example of relative position trees of the related art and the present technology.

FIG. 6 is a block diagram illustrating a configuration example of the mobile apparatus to which the present technology is applied.

FIG. 7 is a view illustrating an example of an update process of the relative position tree in a case where a city map and an indoor map exist.

FIG. 8 illustrates an example of the relative position tree that is updated by the update process in FIG. 7.

FIG. 9 is a view illustrating an example of position information in a plurality of maps.

FIG. 10 is a view illustrating an example of a relative position tree and a movement route in the related art in the case of a city area.

FIG. 11 is a view illustrating an example of a relative position tree and a movement route in the related art in the case of a private land.

FIG. 12 is a view illustrating an example of map coordinate system switching in the related art.

FIG. 13 is a flowchart describing a map transition process in the related art.

FIG. 14 is a view illustrating an example of map coordinate system expansion by the present technology.

FIG. 15 is a view illustrating an example of an expanded map.

FIG. 16 is a flowchart describing a map transition process by a mobile apparatus.

FIG. 17 is a view illustrating comparison along a time axis between the related art and the present technology.

FIG. 18 is a flowchart describing a planning process of a travel route of the mobile apparatus.

FIG. 19 is a flowchart describing an update process of map information in step S112 illustrated in FIG. 18.

FIG. 20 is a view illustrating an example of a first travel route in a city area map and a private land map.

FIG. 21 is a view illustrating an example of a second travel route in the city area map and the private land map.

FIG. 22 is a view illustrating an example of a third travel route in the city area map and the private land map.

FIG. 23 is a view illustrating an example of a fourth travel route in the city area map and the private land map.

FIG. 24 is a view illustrating a configuration example of a mobile body control system to which the present technology is applied.

FIG. 25 is a block diagram illustrating a hardware configuration example of a server.

### DESCRIPTION OF EMBODIMENTS

Hereinafter, embodiments for carrying out the present technology will be described. Description will be given in the following order.

1. Movement Route of Mobile Apparatus

2. Relative Position Tree

3. Configuration Example of Mobile Apparatus

4. Comparison between Related Art and Present Technology in Case of Using Plurality of Maps

5. Effects by Present Technology

6. Mobile Body Control System

7. Others

### 1. Movement Route of Mobile Apparatus

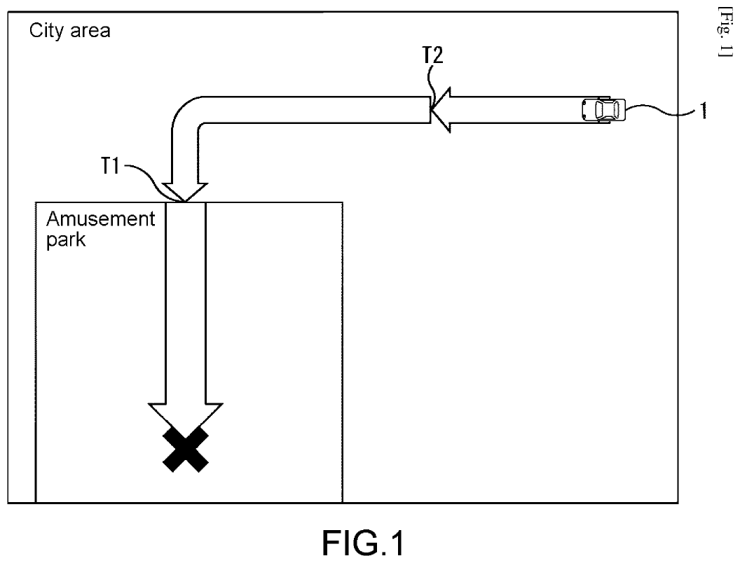

FIG. 1 is a view illustrating an example of a movement route of a mobile apparatus on which an information processing device, to which the present technology is applied, is mounted.

A mobile apparatus 1 is constituted by an automatic drive vehicle that can autonomously move. The mobile apparatus 1 may be constituted by a mobile robot, an entertainment robot, a drone, and the like which are mobile bodies which can autonomously move without limitation to the automatic drive vehicle.

As illustrated in FIG. 1, the mobile apparatus 1 travels in a city area toward an amusement park. The mobile apparatus 1 has city area map information. For example, load information, a position of a parking lot or the like, a rule such as speed restriction, a map origin, an algorithm for obtaining an absolute self-position in a map coordinate system, and the like are included in the map information.

Note that, a “map” is data that describes a corresponding relationship of pieces of information such as “a position, or a position and a posture” and “a location name, a white lane, a signal, and a sign” in a three-dimensional or two-dimensional coordinate system that is fixed in a predetermined space. The “map origin” is the origin of a common coordinate system of information on the map. The map origin is fixed with respect to the earth.

The “map coordinate system” is a common three-dimensional or two-dimensional coordinate system of information on the map in which the map origin is set as the origin.

A “self-position” is a “current” self-position, and is the origin (that is, the central position or the center) of the mobile apparatus 1 that is expressed with a position and a posture of a three-dimensional or two-dimensional space.

A “relative self-position” is a self-position in which the origin of the three-dimensional or two-dimensional space is set to a past self-position among “self-positions”. That is, the relative self-position is a relative position of the current self-position with respect to the past self-position.

A “self-position identification origin” is the origin of the “relative self-position”. The self-position identification origin is frequently set to a self-position at the time of activating the mobile apparatus 1, that is, at the time of initiating movement.

The “absolute self-position” is a self-position in which the origin of the three-dimensional or two-dimensional space is set to the origin of the map coordinate system among “self-positions”. That is, the absolute self-position is a relative position of the current self-position with respect to the origin of the map.

Accordingly, in a case where a past absolute self-position is set as the origin, the “relative self-position” can be calculated from the “absolute self-position”.

The mobile apparatus 1 generates relative position relationship information of a city area map on the basis of city area map information. The relative position relationship information is information that manages a relative position relationship of the origin, the mobile apparatus 1, and an object on the map. The relative position relationship information is constituted by a relative position tree having a tree structure. The mobile apparatus 1 travels on the basis of a travel route that is planned by using the relative position relationship information the city area map.

In addition, the mobile apparatus 1 acquires map information of an amusement park at a timing before entering the amusement park during travel in the city area or the like. The mobile apparatus 1 expands a map coordinate system of the city area in a map coordinate system of the amusement park. That is, the mobile apparatus 1 adds relative position information on the amusement park map to the relative position tree while retaining relative position information in the city area map on the relative position tree, and updates the relative position tree.

According to this, the mobile apparatus 1 can extend a travel route of the city area map when newly planning a travel route of the amusement park. According to this, it is possible to efficiently use a plurality of maps, and it is possible to expect smooth travel of the mobile apparatus 1 between the plurality of maps.

The travel route of the city area that is extended by the amusement part map can be planned every time after a timing T2 at which the map information of the amusement park is acquired and the relative position tree is updated without limitation to a timing T1 before entering the amusement park.

### 2. Relative Position Tree

In a process of the present technology, it is possible to use a “relative position tree” that is relative position relationship information that collectively manages a relative position relationship of the origin, a mobile apparatus, and an object on the map to expand map information in use to another map information. Hereinafter, the relative position tree will be described.

It is necessary to manage a plurality of relative position relationship to calculate a position of the mobile apparatus. Examples of a relative position includes a relative position of the origin of the mobile apparatus with respect to the map origin, a relative position of a sensor with respect to the mobile apparatus, a relative position of a person with respect to the sensor, a relative position of a sign, a traffic signal, or the like with respect to the mobile apparatus. It is necessary to understand a relative position relationship between the map origin and various objects. The origin of the mobile apparatus is a “current” self-position, and is also referred to as host-vehicle origin hereinafter.

The “relative position relationship” represents a relationship of a relative position (or a position and a posture) of two coordinate systems or two objects. The relative position relationship in this specification is a corresponding relationship between the origin of one coordinate system and three-dimensional position and posture of an actual object. The relative position relationship is also referred to as relative position.

Note that, a relative position relationship in which the origin of one coordinate system is set as a reference, and the opposite relationship (that is, a relative position when a non-origin side is set as a reference) can be mutually converted, and acquisition of any one relative position and acquisition of an opposite relationship of the relative position are the same as each other. Accordingly, in this specification, description will be given without discriminating a state in which the relative position can be acquired and a state in which the opposite relationship of the relative position can be acquired.

When a combination of a plurality of relative positions is acquired, it is possible to acquire a new relative position on the basis of the combination of the relative positions. For example, in a case where a relative position of a sensor with respect to the host-vehicle origin and a relative position of a person with respect to the sensor are acquired, it is possible to calculate a relative position of the person with respect to the host-vehicle origin.

In addition, the same relative position can be acquired from a combination of a plurality of different relative positions. For example, in a case where a relative position of a camera sensor with respect to the map origin and a relative position of the camera sensor with respect to the host-vehicle origin are acquired, it is possible to acquire a relative position of the host-vehicle origin with respect to the map origin. In addition, in a case where a relative position of a global positioning system (GPS) antenna with respect to the map origin and a relative position of the GPS antenna with respect to the host-vehicle origin are acquired, it is possible to calculate a relative position of the host-vehicle origin with respect to the map origin.

Originally, it is necessary for the relative position of the host-vehicle origin with respect to the map origin which is calculated by using the camera sensor, and the relative position of the host-vehicle origin with respect to the map origin which is calculated by the GPS antenna to be the same relative position. However, the two relative positions may be different values due to an algorithm of a self-position calculator that is a device that calculates a position or a posture of the host-vehicle origin, a difference of a sensor mounting position, or the like.

The self-position calculator has a configuration in which a reception signal supplied from a GPS or a global navigation satellite system (GNSS) and an inertial measurement unit (IMU) are combined. In addition, the self-position calculator is constituted by a self-position calculator using a simultaneous localization and mapping (SLAM) that performs self-position estimation on the basis of an image captured by a camera, or the like.

As described above, when a relative position different in accordance with the self-position calculator that is used is calculated, there is a concern that a self-position of a mobile apparatus which is calculated by the self-position calculator that is used becomes different. Here, in a process of the present technology, the above-described “relative position tree” is used.

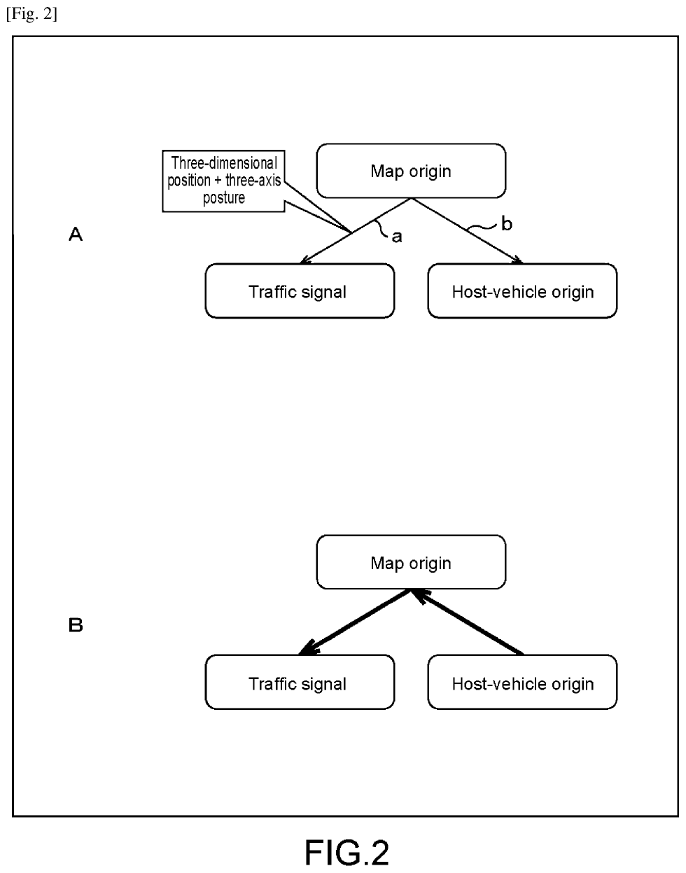

FIG. 2 is a view illustrating an example of the relative position tree.

In FIG. 2, a rectangle represents a node, and an arrow represents a link. As illustrated in A of FIG. 2, the relative position tree has a tree structure in which a plurality of the nodes is linked by the link. The relative position tree is stored in a storage unit of a mobile apparatus.

A link a and a link b, which respectively link the nodes, represent that relative position information between two nodes linked by a link retain as recording information. That is, a relative position of a slave mode on a lower side of the tree with respect to a master node on an upper side of the tree that is linked by a link is stored in the storage unit as recording information.

A of FIG. 2 illustrates a relative position tree in which two relative positions including a relative position of a traffic signal with respect to the map origin and a relative position of the host-vehicle origin with respect to the map origin are set in a tree structure.

As illustrated in A of FIG. 2, for example, relative position information of the link a includes three-dimensional coordinate information indicating a position of the map origin, three-dimensional coordinate information indicating a position of the traffic signal, and corresponding data of posture information (three-axial posture information) of the traffic signal.

Note that, for example, the three-dimensional coordinate information indicating the position of the map origin, and the three-dimensional coordinate information indicating the position of the traffic signal are pieces of information using the same coordinate system, for example, the same map coordinate system.

In addition, for example, relative position information of the link b includes the three-dimensional coordinate information indicating the position of the map origin, and corresponding data of three-dimensional coordinate information indicating a position of the host-vehicle origin.

Note that, for example, the three-dimensional coordinate information indicating the position of the map origin, and the three-dimensional coordinate information indicating the position of the host-vehicle origin are pieces of information using the same coordinate system, for example, the same map coordinate system.

B of FIG. 2 is a view illustrating one process example using the relative position tree illustrated in A of FIG. 2.

When using the relative position tree in which the relative position of the traffic signal with respect to the map origin and the relative position of the host-vehicle origin with respect map origin are defined, it is possible to calculate a relative position of the traffic signal with respect to the host-vehicle origin.

Note that, the tree structure of the relative positions is employed in a robot operating system (ROS) that is a robotics work of an open source.

A relative position of an arbitrary object with respect to the origin of an arbitrary coordinate system, which is storage information of the relative position tree, gradually varies, and thus it is necessary to update the relative position. A relative position of the self-position calculator (sensor) mounted on a mobile apparatus and the map origin gradually varies in accordance with movement of the mobile apparatus, and thus it is necessary to update the relative position.

In the case of performing a process using the relative position tree, it is necessary to provide a module that executes an update process of the relative position tree.

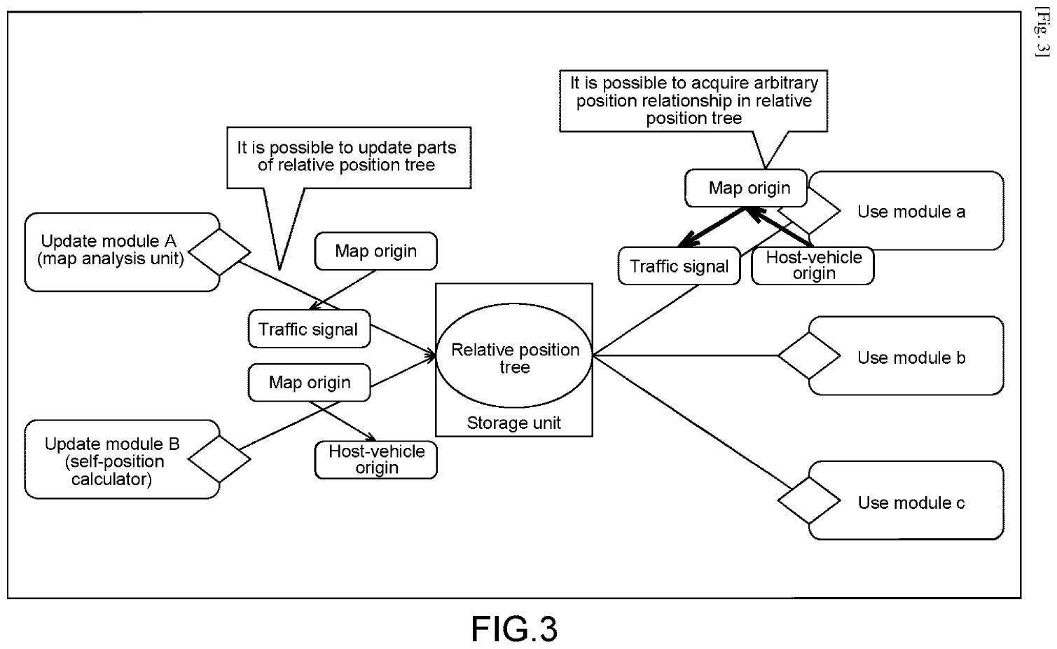

FIG. 3 is a view illustrating an example of the process using the relative position tree.

FIG. 3 illustrates update modules A and B, a storage unit, and use modules a to c.

The update modules A and B execute the update process of the relative position tree. The update modules A and B may be constituted by a map analysis unit that performs analysis of map information, the self-position calculator, or the like.

The update module A (map analysis unit) acquires a relative position of the traffic signal with respect to the map origin on the basis of information obtained from a map, for example, position information of the traffic signal or the like, and performs the update process of the relative position tree stored in the storage unit.

The update module B (self-position calculator) acquires a relative position of the host-vehicle origin with respect to the map origin on the basis of self-position information calculated by the self-position calculator, or the like, and performs the update process of the relative position tree stored in the storage unit.

The relative position tree stored in the storage unit is always updated to the latest information through the update process of the relative position tree.

The storage unit stores the relative position tree. Various pieces of relative position information are acquired by using the relative position tree stored in the storage unit.

The relative position tree stored in the storage unit is read out by the use modules a to c. The use modules a to c use a relative position of an object with respect to the origin of each coordinate system, relative position information of an obstacle with respect to a mobile apparatus, or the like on the basis of the relative position tree, and use the information. Examples of a use aspect of the relative position tree include the process described with reference to B of FIG. 2.

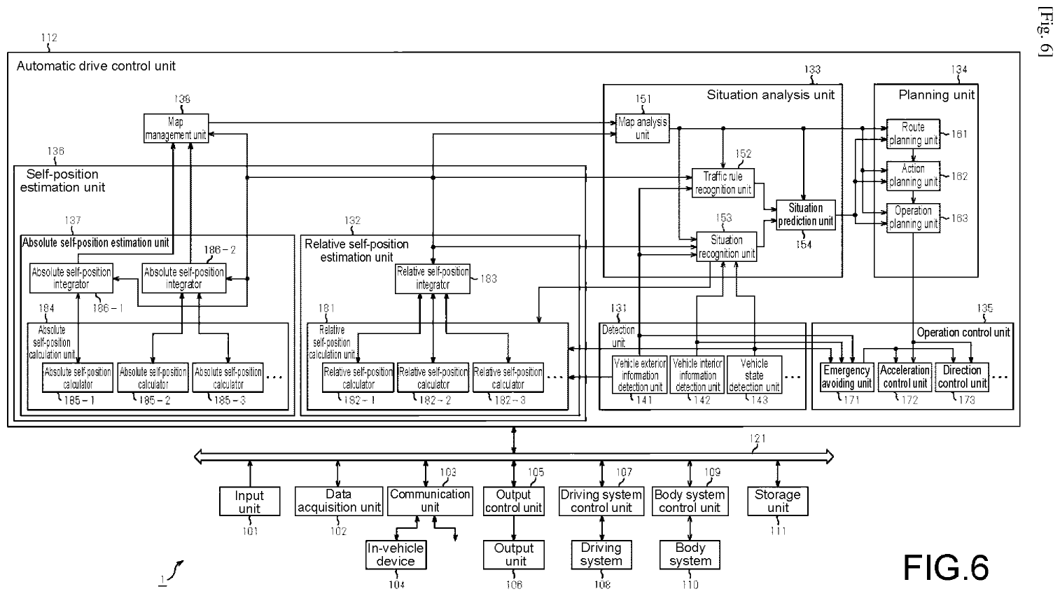

The use modules a to c are a route planning unit that determines a travel route of the mobile apparatus, an action planning unit, an automatic operation planning unit, a drive control unit (FIG. 6 to be described later), and the like.

The use modules a to c can acquire an arbitrary position relationship in the relative position tree by tracing the map origin from the host-vehicle origin, by tracing the traffic signal from the map origin, or the like.

Hereinbefore, description has been given of an example using one map coordinate system. However, in a method of the related art, it is difficult to simultaneously deal with a plurality of map coordinate systems, and thus it is difficult to accomplish smooth travel by the mobile apparatus over a plurality of maps.

In the method of the related art, a mechanism that manages a data structure, a relative position, and a situation was deficient for simultaneously coping with different map coordinate systems and self-position estimation methods.

In a case where an automatic drive vehicle or a robot spreads in the future, it is assumed that maps of all locations indoors and outdoors are organized in order for the automatic drive vehicle and the like to freely move. It is difficult to assume that all maps are open from the viewpoints of privacy or security. It is assumed that a map of a private land or the like is possessed by an owner, and is disclosed to a specific automatic drive vehicle or robot for which the map is permitted.

For example, the automatic drive vehicle travels on a public road and in an amusement park toward a destination that exists in the amusement park. A map of the public road is opened. The map inside the amusement park is opened to only a user in a limited period. The automatic drive vehicle travels up to an entrance of the amusement park by using the map of the public road from a house of an occupant, and presents a ticket of the amusement park in an electronic manner, and obtains the map inside the amusement park at that time. After entering the amusement park, the automatic drive vehicle travels up to the destination by using the map inside the amusement park, and after an occupant gets off, the automatic drive vehicle moves to a parking lot and parks in the parking lot.

In this case, the map of the public road and the map inside the amusement park independently exist. In the method of the related art, it is difficult to simultaneously deal with two maps, and thus switching of maps occurs at the entrance, and thus smooth travel is difficult.

For example, when describing all maps with the same coordinate system (for example, a map coordinate system using a GPS signal) and providing a mechanism that manages a map access authority, it seems that smooth travel over maps is possible.

However, it is difficult to deal with all maps with the same coordinate system from the viewpoint of measurement accuracy. When generating maps of private lands, indoors, and the like, it is difficult to maintain sufficient high accuracy by performing measurement with a map coordinate system using the GPS signal.

In addition, in addition to the viewpoint of the measurement accuracy, in the method of the related art, it is difficult to deal with a different absolute self-position estimation method which is capable of performing estimation in a map or a location.

An assumption will be made about a robot capable of performing travel on a public road and indoor travel. During travel on the public road, an absolute self-position is estimated by a GPS signal. At indoors, the GPS signal is not acquired, and thus the robot estimates the absolute self-position by recognizing marker detection or an image feature during indoor travel.

In this case, it is necessary to switch a different absolute self-position estimation method or to execute the estimation method in parallel. However, in the method of the related art, it is difficult to simultaneously deal with two different absolute self-position estimation methods.

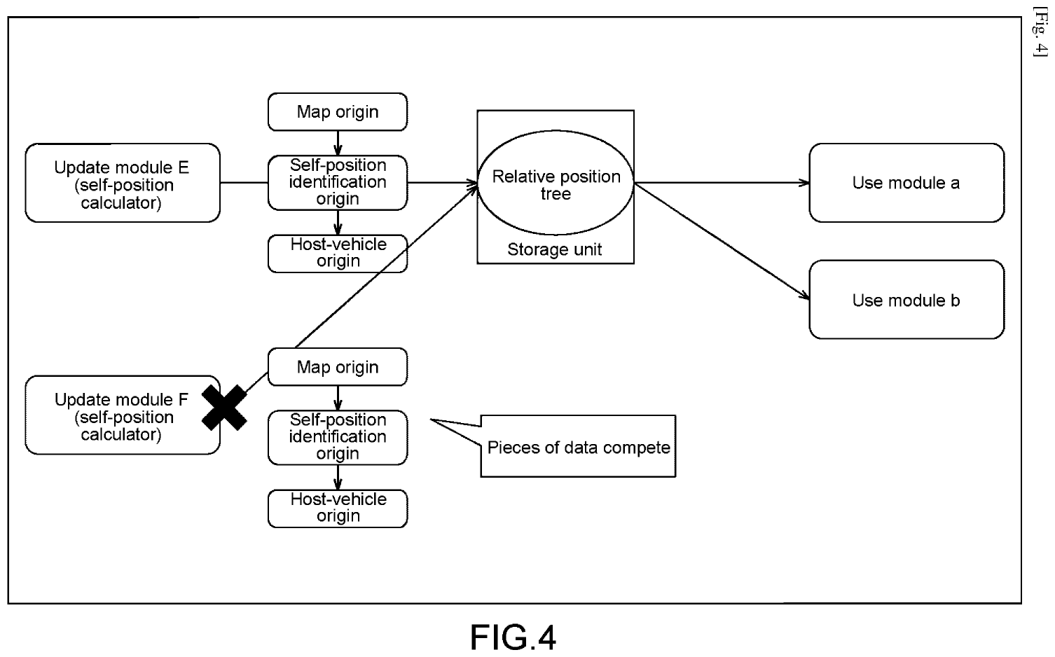

FIG. 4 is a view illustrating an example of a process using the relative position tree as in FIG. 3.

In FIG. 4, update modules E and F, the storage unit, and the use modules a and b are illustrated.

In FIG. 4, the update module E is constituted by a self-position calculator that performs self-position calculation with an algorithm E1. The update module F is constituted by a self-position calculator that performs self-position calculation with an algorithm F1 different from the algorithm E1. The other configurations are the same as in the configurations described with reference to FIG. 3.

In the configurations illustrated in FIG. 4, the update module E (self-position calculator) performs position calculation using the algorithm E1. The update module E acquires a relative position of a self-position identification origin with respect to the map origin and a relative position of the host-vehicle origin with respect to the self-position identification origin on the basis of position information that is calculated, generates configuration information of the relative position tree, and performs a update process of the relative position tree stored in the storage unit.

Configuration information E2 of the relative position tree includes the relative position of the self-position identification origin with respect to the map origin and the relative position of the host-vehicle origin with respect to the self-position identification origin.

On the other hand, the update module F performs position calculation using the algorithm F1. The update module F acquires a relative position of the self-position identification origin with respect to the map origin and a relative position of the host-vehicle origin with respect to the self-position identification origin on the basis of the calculated position information, generates configuration information of the relative position tree, and performs an update process of the relative position tree stored in the storage unit.

Configuration information F2 of the relative position tree includes the relative position of the self-position identification origin with respect to the map origin and the relative position of the host-vehicle origin with respect to the self-position identification origin.

The configuration information E2 of the relative position tree which is generated by the update module E is the relative position of the self-position identification origin with respect to the map origin, and the relative position of the host-vehicle origin with respect to the self-position identification origin. The configuration information F2 of the relative position tree which is generated by the update module F of the relative position tree is the relative position of the self-position identification origin with respect to the map origin, and the relative position of the host-vehicle origin with respect to the self-position identification origin.

An update process of the relative position tree is performed by using the configuration information E2 of the relative position tree and the configuration information F2 of the relative position tree. Accordingly, information competition occurs due to the pieces of configuration information of relative position tree which are generated by the two update module.

When the two pieces of configuration information match each other, and are constituted by completely the same data, it is possible to update the relative position tree stored in the storage unit with common configuration information.

However, the two update modules E and F are modules which perform a position information calculation process by algorithms different from each other. In addition, in the two update modules E and F, installation positions of position calculation sensors are also different from each other.

Accordingly, in many cases, pieces of position information calculated by the two modules hardly match each other, and a difference occurs.

In this case, when updating the relative position tree stored in the storage unit on the basis of position information calculated by any one self-position calculator, mismatching with position information calculated by another self-position calculates occurs. When the mismatching occurs, an error with an actual relative position also occurs in a process using the relative position in a use module, and there is a possibility that a problem such as contact between the mobile apparatus and an obstacle may occur.

As described above, when using a plurality of different self-position calculators as an update module of the relative position tree, a deviation occurs in pieces of position information which are respectively calculated by the self-position calculators. According to this, in a configuration using the relative position tree, it is difficult to apply a configuration using the self-position calculators by a plurality of different algorithms.

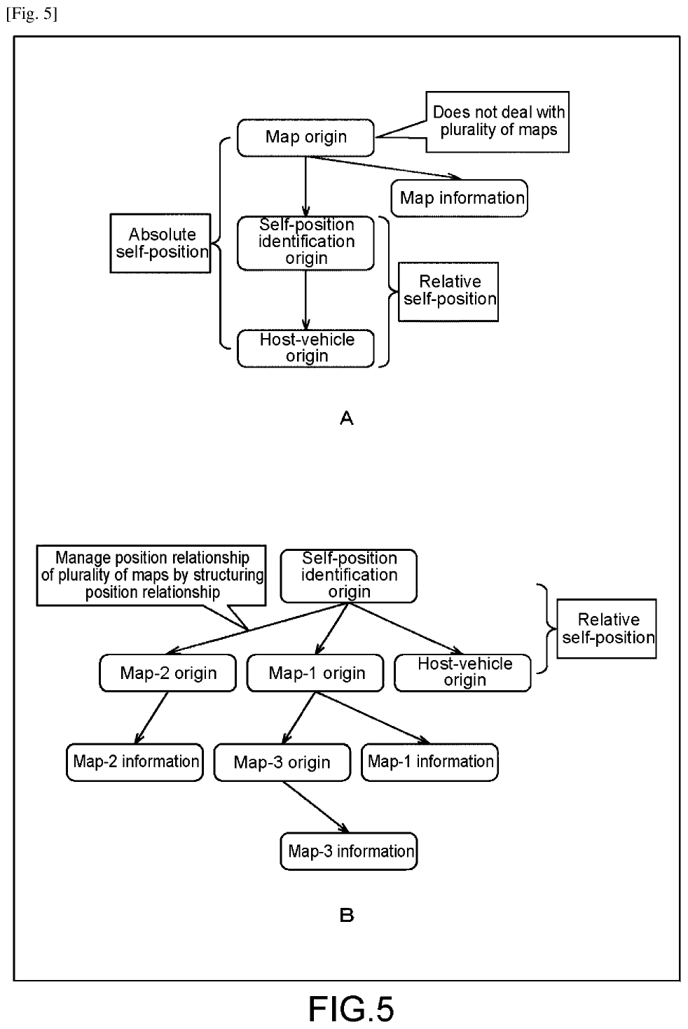

FIG. 5 is a view illustrating an example of relative position trees of the related art and the present technology.

In the present technology, a map origin is added to a relative position tree in correspondence with the number of map coordinate systems. The map origin is added as a slave node of the self-position identification origin or another map origin.

Here, the “self-position identification origin” is the origin of a relative self-position that is output from a relative self-position estimation unit to be described later. As described above, the self-position identification origin is set as a self-position in activation of the mobile apparatus in many cases.

The “slave node” is a slave node in a relative position tree that is a rooted tree. The origin of the relative position tree is a master node, and an object is the slave node.

A “descendant node” is a slave node of the “slave node”.

A of FIG. 5 illustrates an example of the relative position tree of the related art.

In the relative position tree of the related art, as illustrated in A of FIG. 5, a self-position identification origin and map information as a slave node of the map origin are linked by a link. As a slave node of the self-position identification origin, that is, as a descendant node of the map origin, a host-vehicle origin is linked by a link.

In the relative position tree of the related art, the map origin and the host-vehicle origin have an absolute self-position relationship of the host-vehicle origin with respect to the map origin, and the self-position identification origin and the host-vehicle origin have a relative self-position relationship.

In the relative position tree of the related art, as illustrated in A of FIG. 5, the map origin becomes a master node of the self-position identification origin. In a structure of the relative position tree, a plurality of master nodes is not provided.

Accordingly, in the relative position tree, only one map origin exists synchronously. Map information with which a relative position with the host-vehicle origin can be obtained is only map information having the same map origin.

B of FIG. 5 illustrates an example of the relative position tree of the present technology.

In the relative position tree of the present technology, as illustrated in B of FIG. 5, as a slave node of the self-position identification origin, a map-1 origin and a map-2 origin, and the host-vehicle origin are linked by a link. As a slave node of the map-2 origin and as a descendant node of the self-position identification origin, map-2 information is linked by a link. As a slave node of the map-1 and a descendant node of the self-position identification origin, a map-3 origin and map-1 information are linked by a link. As a slave node of the map-3 origin and as a descendant node of the self-position identification origin and the map-1 information, map-3 information is linked by a link.

In the relative position tree of the present technology, the map-2 origin, the map-1 origin, and the host-vehicle origin which are slave nodes have a relative self-position relationship with the self-position identification origin.

In the present technology, as illustrated in B of FIG. 5, the map origin becomes a slave node of the self-position identification origin or another map origin, and thus it is possible to link a plurality of map origins to one tree.

In addition, in the present technology, the map origin (the origin of an absolute self-position) can be linked as a descendant node of the self-position identification origin instead of a descendant node of the host-vehicle origin.

The reason for this is as follows. The self-position identification origin and the map origin are coordinate systems fixed to a space, and thus it is considered that a relative position of the map origin with respect to the self-position identification origin is fixed.

A relative position of the map origin with respect to a self-position identification origin that is estimated in the past does not vary when an error is not considered, and thus the relative position can be used also when estimation cannot be performed. Note that, a relative position of the host-vehicle origin with respect to the map origin varies as long as the host-vehicle origin moves, and thus it is necessary to constantly update the relative position.

### 3. Configuration Example of Mobile Apparatus

FIG. 6 is a block diagram illustrating a configuration example of the mobile apparatus illustrated in FIG. 1.

In FIG. 6, the mobile apparatus 1 includes a vehicle control system. That is, the vehicle control system in FIG. 6 is provided in the mobile apparatus 1 in FIG. 1.

Note that, hereinafter, in the case of being distinguished from another vehicle, the vehicle provided with the vehicle control system is referred to as host vehicle.

The vehicle control system includes an input unit 101, a data acquisition unit 102, a communication unit 103, an in-vehicle device 104, an output control unit 105, and an output unit 106. The vehicle control system includes a driving system control unit 107, a driving system 108, a body system control unit 109, a body system 110, a storage unit 111, and an automatic drive control unit 112.

The input unit 101, the data acquisition unit 102, the communication unit 103, the output control unit 105, the driving system control unit 107, the body system control unit 109, the storage unit 111, and the automatic drive control unit 112 are connected to each other through a communication network 121.

The communication network 121 includes an in-vehicle communication network conforming to arbitrary standards such as a controller area network (CAN), a local interconnect network (LIN), a local area network (LAN), and FlexRay (registered trademark), a bus, or the like. Note that, respective units of the vehicle control system may be directly connected through the communication network 121.

Note that, hereinafter, in a case where the respective units of the vehicle control system perform communication through the communication network 121, description of the communication network 121 will be omitted. For example, in a case where the input unit 101 and the automatic drive control unit 112 perform communication through the communication network 121, simply, it will be described that the input unit 101 and the automatic drive control unit 112 perform communication.

The input unit 101 includes a device that is used by an occupant to input various pieces of data, instructions, or the like. For example, the input unit 101 includes an operation device such as a touch panel, a button, a microphone, a switch, and a lever, and the like. In addition, the input unit 101 includes an operation device capable of performing input with a voice or gesture by a method other than manual operation, and the like.

The input unit 101 may be a remote control device using infrared rays or other electric waves. In addition, the input unit 101 may be an external connection device such as a mobile device or a wearable device which corresponds to an operation of the vehicle control system.

The input unit 101 generates an input signal on the basis of data, an instruction, or the like which is input by an occupant, and outputs the input signal to respective units of the vehicle control system.

The data acquisition unit 102 includes various sensors and the like which acquire data that is used in processes of the vehicle control system, and outputs acquired data to respective units of the vehicle control system.

The data acquisition unit 102 includes various sensors which detect a state of a host vehicle, or the like. Specifically, the data acquisition unit 102 a gyro sensor, an acceleration sensor, an IMU, and the like. The data acquisition unit 102 also includes respective sensors which detect an operation amount of an acceleration pedal, an operation amount of a brake pedal, a steering angle of a steering wheel, the number of revolutions of an engine, the number of revolutions of a motor, a rotation speed of wheels, and the like.

In addition, the data acquisition unit 102 includes various sensors which detect external information of the host vehicle. Specifically, the data acquisition unit 102 includes imaging devices such as a time of flight (ToF) camera, a stereo camera, a monocular camera, an infrared camera, and other cameras.

The data acquisition unit 102 includes an environment sensor that detects weather, meteorological phenomena, or the like, and a nearby information detection sensor that detects an object nearby the host vehicle. The environment sensor includes a raindrop sensor, a fog sensor, a sunshine sensor, a snow sensor, and the like. The nearby information detection sensor includes an ultrasonic sensor, a radar, and a light detection and ranging, laser imaging detection and ranging (LiDAR), a sonar, or the like.

In addition, the data acquisition unit 102 includes various sensors which detect a current position of the host vehicle. Specifically, the data acquisition unit 102 includes a GPS receiver that receives a GPS signal supplied from a GPS satellite, a GNSS receiver that receives a GNSS signal supplied from a GNSS satellite, or the like.

The data acquisition unit 102 outputs the GPS signal or the GNSS signal to any one of absolute self-position calculators 185-1 to 185-n. The data acquisition unit 102 outputs an image signal transmitted from an imaging device, a camera that detects a marker, or the like to any one of the absolute self-position calculators 185-1 to 185-n.

In addition, the data acquisition unit 102 includes various sensors which detect vehicle interior information. Specifically, the data acquisition unit 102 includes an imaging device that captures an image of a driver, a biological sensor that detects biological information of the driver, a microphone that collects a vehicle interior sound, and the like. For example, the biological sensor is provided on a seating surface, a steering wheel, or the like, and detects biological information of an occupant who sits on a seat, or a driver who grips the steering wheel.

The data acquisition unit 102 acquires data from the storage unit 111, and outputs the data to respective units of the vehicle control system. The data acquisition unit 102 acquires structure data of the host vehicle from the storage unit 111, and provides the data to a relative self-position estimation unit 132, or the like.

The communication unit 103 performs communication with the in-vehicle device 104, various vehicle exterior devices, a server, a base station, and the like. For example, the communication unit 103 transmits data supplied from respective units of the vehicle control system, or supplies received data to respective units of the vehicle control system. Note that, a communication protocol supported by the communication unit 103 is not particularly limited, and the communication unit 103 may support a plurality of kinds of communication protocols.

The communication unit 103 performs wireless communication with the in-vehicle device 104 by wireless LAN, Bluetooth (registered trademark), near field communication (NFC), wireless USB (WUSB), or the like. In addition, the communication unit 103 performs wired communication with the in-vehicle device 104 by a universal serial bus (USB), High-Definition Multimedia Interface (HDMI) (registered trademark), and a mobile high-definition link (MHL) through a connection terminal (and a cable as necessary).

In addition, the communication unit 103 performs communication with a device (an application server or a control server) that exists on an external network (the Internet, a cloud network, or a company-specific network) through a base station or an access point. The communication unit 103 performs communication with a terminal that exists in the vicinity of the host vehicle (for example, a terminal of a pedestrian or a shop, or a machine type communication (MTC) terminal) by using a peer to peer (P2P) technology.

In addition, the communication unit 103 performs V2X communication such as vehicle to vehicle communication, vehicle to infrastructure communication, vehicle to home communication, and vehicle to pedestrian communication. The communication unit 103 includes a signal reception unit, receives electric waves or electromagnetic waves transmitted from a radio station provided on a road, or the like, and acquires information such as a current position, delay, traffic regulation, and a required time.

For example, the in-vehicle device 104 includes a mobile device or a wearable device that is carried by an occupant, an information device that is conveyed into or mounted on the host vehicle, a navigation device that performs retrieval of a route up to an arbitrary destination site, and the like.

The output control unit 105 controls output of various pieces of information with respect to an occupant of the host vehicle or a vehicle exterior. For example, the output control unit 105 generates an output signal and outputs the output signal to the output unit 106 to control output of visual information and auditory information which are supplied from the output unit 106. The output signal includes at least one of visual information (for example, image data) or auditory information (for example, voice data).

Specifically, the output control unit 105 combines pieces of image data captured by different imaging devices of the data acquisition unit 102, generates an overhead view image, a panoramic image, or the like, and outputs an output signal including the generated image to the output unit 106. An alarm sound or an alarm message is a sound or a message against danger such as collision, contact, entrance into a dangerous area, and the like. In addition, the output control unit 105 generates voice data including the alarm sound, the alarm message, or the like, and outputs an output signal including the generated voice data to the output unit 106.

The output unit 106 includes a device capable of outputting visual information or auditory information with respect to an occupant of the host vehicle or a vehicle exterior. For example, the output unit 106 includes a display device, an instrumental panel, an audio speaker, a headphone, a wearable device such as an eyeglass-type display which the occupant wears, a projector, a lamp, and the like.

For example, the display device provided in the output unit 106 may be a device that displays visual information within a visual field of a driver such as a head-up display, a transmission-type display, a device having an augmented reality (AR) display function in addition to a device including a typical display.

The driving system control unit 107 generates various control signals and outputs the signals to the driving system 108 to perform control of the driving system 108. In addition, the driving system control unit 107 outputs the control signals to respective units other than the driving system 108, and gives a notification of a control state of the driving system 108 as necessary.

The driving system 108 includes various devices relating to the driving system of the host vehicle. The driving system 108 includes a driving force generating device that generates a driving force such as an internal combustion engine and a driving motor, a driving force transmission mechanism that transmits the driving force to wheels, a steering mechanism that adjusts a steering angle, a braking device that generates a braking force, an antilock brake system (ABS), electronic stability control (ESC), an electric power steering device, and the like.

The body system control unit 109 generates various control signals and outputs the control signals to the body system 110 to perform control of the body system 110. In addition, the body system control unit 109 supplies the control signals to respective units other than the body system 110, and gives a notification of a control state of the body system 110 as necessary.

The body system 110 includes various body system devices mounted on a vehicle body. For example, the body system 110 includes a keyless entry system, a smart keying system, a power window device, a power seat, a steering wheel, an air conditioning device, and various lamps. Examples of the various lamps include a head lamp, a back lamp, a brake lamp, a winker, and a fog lamp.

For example, the storage unit 111 includes a magnetic storage device such as a read only memory (ROM), a random access memory (RAM), and a hard disc drive (HDD), a semiconductor storage device, an optical storage device, a magneto-optical device, and the like.

The storage unit 111 stores various programs, various pieces of data, and the like which are used by respective units of the vehicle control system. The storage unit 111 stores map information such as a three-dimensional high-accuracy map such as a dynamic map, a global map of which accuracy is lower than that of the high-accuracy map and which covers a wide area, and a local map including nearby information of the host vehicle. The storage unit 111 also stores vehicle body structure data of the host vehicle, and the like. In addition, the storage unit 111 stores the relative position tree, and the like.

The automatic drive control unit 112 performs control relating to automatic drive such as autonomous travel or drive assistance. Specifically, the automatic drive control unit 112 may perform cooperative control to realize advanced driver assistance system (ADAS) functions including collision avoidance or impact mitigation of the host vehicle, following travel based on an inter-vehicle distance, vehicle-speed maintaining travel, host vehicle collision alarm, and host vehicle lane departure alarm, and the like. In addition, the automatic drive control unit 112 performs cooperative control to realize automatic drive and the like in which a vehicle autonomously travels without regardless of a driver's operation.

The automatic drive control unit 112 includes a detection unit 131, a relative self-position estimation unit 132, a situation analysis unit 133, a planning unit 134, and an operation control unit 135.

The detection unit 131 performs detection of various pieces of information necessary for control of automatic drive. The detection unit 131 includes a vehicle exterior information detection unit 141, a vehicle interior information detection unit 142, and a vehicle state detection unit 143.

The vehicle exterior information detection unit 141 performs a detection process of host vehicle exterior information on the basis of data or a signal (hereinafter, the data and the signal are collectively referred to as information) which is supplied from respective units of the vehicle control system. The vehicle exterior information detection unit 141 performs a detection process, a recognition process, and a tracking process of an object nearby the host vehicle, and a detection process of a distance to the object. Examples of the object as a detection target include vehicles, human beings, obstacles, structures, roads, traffic signals, traffic signs, road signs, and the like.

In addition, the vehicle exterior information detection unit 141 performs a detection process of an environment nearby the host vehicle. Examples of the nearby environment as a detection target include weather, a temperature, humidity, brightness, a road surface state, and the like. The vehicle exterior information detection unit 141 outputs data indicating a result of the detection process to the relative self-position estimation unit 132, a map analysis unit 151, a traffic rule recognition unit 152, and a situation recognition unit 153 of the situation analysis unit 133, an emergency avoiding unit 171 of the operation control unit 135, and the like.

The vehicle interior information detection unit 142 performs a detection process of vehicle interior information on the basis of the information that is supplied from respective units of the vehicle control system. For example, the vehicle interior information detection unit 142 performs an authentication process and a recognition process of a driver, a detection process of a driver's state, a detection process of an occupant, a detection process of a vehicle interior environment, and the like.

Examples of the driver's state as a detection target include a physical condition, an awakening degree, a concentration degree, a fatigue degree, a visual line direction, and the like. Examples of the vehicle interior environment as a detection target include a temperature, humidity, brightness, smelling, and the like. The vehicle interior information detection unit 142 outputs data indicating a result of the detection process to the situation recognition unit 153 of the situation analysis unit 133, the emergency avoiding unit 171 of the operation control unit 135, and the like.

The vehicle state detection unit 143 performs a detection process of a state of the host vehicle on the basis of information that is supplied from respective units of the vehicle control system. Examples of the state of the host vehicle as a detection target include a speed, acceleration, a steering angle, presence/absence and content of abnormality, a drive operation state, a position and an inclination of a power sheet, a state of a door lock, states of other in-vehicle devices, and the like. The vehicle state detection unit 143 outputs data indicating a result of the detection process to the relative self-position estimation unit 132, the situation recognition unit 153 of the situation analysis unit 133, the emergency avoiding unit 171 of the operation control unit 135, and the like.

The relative self-position estimation unit 132 estimates a relative self-position of the host vehicle. As described above, the relative self-position is a self-position in which the origin of a three-dimensional space is set to a past self-position among self-positions indicating a position and a posture in the three-dimensional space of the host vehicle. The relative self-position estimation unit 132 includes a relative self-position calculation unit 181, relative self-position calculators 182-1 to 182-n, and a relative self-position integration unit 183.

The relative self-position calculation unit 181 an estimation process of a position, a posture, and the like of the host vehicle on the basis of information that is supplied from the data acquisition unit 102, the vehicle state detection unit 143, the vehicle exterior information detection unit 141, the situation recognition unit 153 of the situation analysis unit 133, and the like. The relative self-position calculation unit 181 includes one or more relative self-position calculators 182-1 to 182-n.

The relative self-position calculators 182-1 to 182-n performs an estimation process of the position, the posture, and the like of the host vehicle on the basis of information that is supplied from the data acquisition unit 102, the vehicle state detection unit 143, the vehicle exterior information detection unit 141, the situation recognition unit 153 of the situation analysis unit 133, and the like.

The relative self-position integration unit 183 outputs a relative self-position that is a result obtained by integrating relative self-positions supplied from the one or more relative self-position calculators 182-1 to 182-n by an integration method.

The relative self-position integration unit 183 outputs data indicating the relative self-position that is the integration result to the map analysis unit 151, the traffic rule recognition unit 152, and the situation recognition unit 153 of the situation analysis unit 133, and the like. The data indicating the relative self-position is also supplied to an absolute self-position integrator 186-2 and a map management unit 138.

The situation analysis unit 133 performs an analysis process of a host vehicle situation and a nearby situation. The situation analysis unit 133 includes the map analysis unit 151, the traffic rule recognition unit 152, the situation recognition unit 153, and a situation prediction unit 154.

The map analysis unit 151 performs an analysis process of various maps stored in the storage unit 111 while using information that is supplied from respective units of the vehicle control system such as the relative self-position estimation unit 132 and the vehicle exterior information detection unit 141 as necessary.

In a case where a plurality of maps exists, relative position tree information supplied from the map management unit 138 is referred to. The relative position tree information may be used to analyze information described in a map and a relative self-position. In addition, the map analysis unit 151 acquires a relative position of the traffic signal with respect to the map origin on the basis of information obtained from the map, for example, position information of the traffic signal or the like, and performs an update process of the relative position tree stored in the storage unit 111.

The map analysis unit 151 constructs a map including information necessary for a process of automatic drive. For example, the map analysis unit 151 expands a map coordinate system on the basis of the relative position tree supplied from the map management unit 138, and constructs a map in which the map coordinate system is expanded. The map analysis unit 151 outputs a constructed map to the traffic rule recognition unit 152, the situation recognition unit 153, the situation prediction unit 154, a route planning unit 161, an action planning unit 162, and an operation planning unit 163 of the planning unit 134, and the like.

The traffic rule recognition unit 152 performs a recognition process of a traffic rule nearby the host vehicle on the basis of information that is supplied from respective units of the vehicle control system such as the relative self-position estimation unit 132, the vehicle exterior information detection unit 141, and the map analysis unit 151. Through the recognition process, for example, a position and a state of the traffic signal nearby the host vehicle, the content of traffic regulation nearby the host vehicle, a travel-possible lane, and the like are recognized. The traffic rule recognition unit 152 outputs data indicating a result of the recognition process to the situation prediction unit 154, or the like.

The situation recognition unit 153 performs a recognition process of a situation relating to the host vehicle on the basis of information that is supplied from respective units of the vehicle control system. Examples of the respective units of the vehicle control system include the relative self-position estimation unit 132, the vehicle exterior information detection unit 141, the vehicle interior information detection unit 142, the vehicle state detection unit 143, the map analysis unit 151, and the like. For example, the situation recognition unit 153 performs a recognition process of a situation of the host vehicle, a nearby situation of the host vehicle, a situation of a driver of the host vehicle, and the like. In addition, the situation recognition unit 153 generates a local map (hereinafter, referred to as situation recognition map) that is used in recognition of the nearby situation of the host vehicle. For example, the situation recognition map is set as an occupancy grid map.

Examples of the situation of the host vehicle as a recognition target include a position, a posture, movement (for example, a speed, acceleration, a movement direction, and the like) of the host vehicle, presence/absence and content of abnormality, and the like. Examples of the nearby situation of the host vehicle as a recognition target include a kind and a position of a nearby stationary object, a kind, a position, and movement a nearby moving object, a configuration and a road surface state of a nearby road, nearby weather, a nearby temperature, nearby humidity, nearby brightness, and the like. Examples of the state of the driver as a recognition target include a physical condition, an awakening degree, a concentration degree, a fatigue degree, a visual line movement, a drive operation, and the like.

The situation recognition unit 153 outputs data (including the situation recognition map as necessary) indicating a result of the recognition process to the relative self-position estimation unit 132, the situation prediction unit 154, and the like. In addition, the situation recognition unit 153 stores the situation recognition map in the storage unit 111.

The situation prediction unit 154 performs a prediction process of a situation relating to the host vehicle on the basis of information that is supplied from respective units of the vehicle control system such as the map analysis unit 151, the traffic rule recognition unit 152, and the situation recognition unit 153. For example, the situation prediction unit 154 performs a prediction process of a situation of the host vehicle, a nearby situation of the host vehicle, and a situation of a driver.

Examples of the situation of the host vehicle as a prediction target include a behavior of the host vehicle, occurrence of abnormality, a travel-possible distance, and the like. Examples of the nearby situation of the host vehicle as a prediction target include a behavior of a moving object nearby the host vehicle, a state variation of a signal, a variation of an environment such as weather, and the like. Examples of the situation of the driver as a prediction target include a behavior and a physical condition of the driver, and the like.

The situation prediction unit 154 outputs data indicating a result of the prediction process to the route planning unit 161, the action planning unit 162 and the operation planning unit 163 of the planning unit 134, and the like in combination with the data that is supplied from the traffic rule recognition unit 152 and the situation recognition unit 153.

The route planning unit 161 plans a travel route to a destination on the basis of information that is supplied from respective units of the vehicle control system such as the map analysis unit 151 and the situation prediction unit 154. For example, the route planning unit 161 sets a travel route to a destination designated from a current position on the basis of the expanded map information. In addition, for example, the route planning unit 161 appropriately changes the route on the basis of situations such as delay, accident, traffic regulation, and construction, a physical condition of the driver, and the like. The route planning unit 161 outputs data indicating the planned travel route to the action planning unit 162, or the like.

The action planning unit 162 plans an action of the host vehicle for safe travel along the travel route planned by the route planning unit 161 within a planned time on the basis of information that is supplied from the map analysis unit 151, the situation prediction unit 154, and the like. For example, the action planning unit 162 performs planning of departure, stopping, a running direction (for example, advancing, retraction, turning left, turning right, direction switching, and the like), a travel lane, a travel speed, passing, and the like. The action planning unit 162 outputs data indicating the planned action of the host vehicle to the operation planning unit 163, or the like.

The operation planning unit 163 plans an operation of the host vehicle for realizing the action planned by the action planning unit 162 on the basis of information that is supplied from respective units of the vehicle control system such as the map analysis unit 151 and the situation prediction unit 154. For example, the operation planning unit 163 performs planning of acceleration, deceleration, a travel trajectory, and the like. The operation planning unit 163 outputs data indicating the planned operation of the host vehicle to an acceleration/deceleration control unit 172 and a direction control unit 173 of the operation control unit 135, and the like.

The operation control unit 135 performs control of an operation of the host vehicle. The operation control unit 135 includes the emergency avoiding unit 171, the acceleration/deceleration control unit 172, and the direction control unit 173.

The emergency avoiding unit 171 performs a detection process of collision, contact, entrance into a dangerous area, abnormality of a driver, and arbitrary abnormal emergency of a vehicle on the basis of detection results of the vehicle exterior information detection unit 141, the vehicle interior information detection unit 142, and the vehicle state detection unit 143. In the case of detecting emergency, the emergency avoiding unit 171 plans an operation of the host vehicle for avoiding the emergency such as rapid stopping and rapid turning. The emergency avoiding unit 171 outputs data indicating the planned operation of the host vehicle to the acceleration/deceleration control unit 172, the direction control unit 173, and the like.

The acceleration/deceleration control unit 172 performs acceleration/deceleration control for realizing the host vehicle operation planned by the operation planning unit 163 or the emergency avoiding unit 171. For example, the acceleration/deceleration control unit 172 computes a control target value of the driving force generation device or the braking device for realizing planned acceleration, planned deceleration, or planned rapid stopping. The acceleration/deceleration control unit 172 outputs a control command indicating a computed control target value to the driving system control unit 107.

The direction control unit 173 performs direction control for realizing the host vehicle operation planned by the operation planning unit 163 or the emergency avoiding unit 171. For example, the direction control unit 173 computes a control target value of a steering mechanism for realizing the travel trajectory or the rapid turning which is planned by the operation planning unit 163 or the emergency avoiding unit 171, and outputs a control command indicating the computed control target value to the driving system control unit 107.

A self-position estimation unit 136 estimates an absolute self-position of the host vehicle, and a relative self-position of the host vehicle. The self-position estimation unit 136 includes the relative self-position estimation unit 132 and an absolute self-position estimation unit 137.

The absolute self-position estimation unit 137 estimates an absolute self-position of the host vehicle. As described above, the absolute self-position represents a position and a posture of the host vehicle in a three-dimensional space. The origin of a three-dimensional space coordinate at this time is any one map origin. The coordinate system a map coordinate of a corresponding map. The absolute self-position estimation unit 137 includes an absolute self-position calculation unit 184, and a plurality of absolute self-position integrators 186-1 and 186-2.

The absolute self-position estimation unit 137 includes the plurality of absolute self-position calculators 185-1 to 185-n. The absolute self-position calculators 185-1 to 185-n performs an estimation process of an absolute self-position on the basis of information that is supplied from the data acquisition unit 102, the vehicle state detection unit 143, the vehicle exterior information detection unit 141, the situation recognition unit 153 of the situation analysis unit 133, and the like.

In any one of the absolute self-position calculators 185-1 to 185-n, it is possible to use an algorithm for obtaining an absolute self-position included in acquired map information, and an estimation process of the absolute self-position is performed. A coordinate system that describes the absolute self-position is a map coordinate system, but it is not necessary for all absolute self-positions to be a map coordinate system of the same map. In a case where an identification method of the absolute self-position and the map coordinate system are different, a different absolute self-position calculator is constructed.

For example, as described above, the absolute self-position calculator 185-1 has a configuration in which a reception signal supplied from the GPS or the GNSS, and the IMU are combined. As described above, the absolute self-position calculator 185-2 has a configuration using the SLAM in which self-position estimation is performed on the basis of an image captured by a camera. There is a self-position calculator having a configuration in which self-position estimation is performed on the basis of marker. As described above, algorithms used by the absolute self-position calculators 185-1 to 185-n to perform self-position estimation are not limited to be the same as each other, and may be different from each other.

The absolute self-position integrators 186-1 and 186-2 exist in the number of map coordinate systems. The absolute self-position integrators 186-1 and 186-2 respectively integrate results of the absolute self-position calculators 185 in the same map coordinate system among the absolute self-position calculators 185-1 to 185-n.

The absolute self-position integrator 186-1 integrates outputs of the plurality of absolute self-position calculators 185-1, and outputs an integrated absolute self-position to the map management unit 138. The absolute self-position integrator 186-2 integrates outputs of the plurality of absolute self-position calculators 185-2 and 185-3, and outputs an integrated absolute self-position to the map management unit 138.

At this time, the self-position integrators 186-1 and 186-2 integrates relative self-positions supplied from the relative self-position estimation unit 132. In a number of absolute self-position estimation methods, estimation cannot be performed in some cases, and thus the absolute self-position integrators 186-1 and 186-2 performs compensation of the absolute self-position by a method such as a Kalman filter and a particle filter by using a relative self-position. The integrated absolute self-position exists in the number of the origins of maps, and is output to the map management unit 138.

Note that, in a case where it is not necessary to distinguish the absolute self-position integrators 186-1 and 186-2, the integrators are collectively referred to as absolute self-position integrator 186. In a case where it is not necessary to distinguish the absolute self-position calculators 185-1 to 185-n, the integrators are collectively referred to as absolute self-position calculator 185.

The map management unit 138 manages a position relationship of a plurality of maps on the basis of the absolute self-position that is supplied from the absolute self-position integrator 186, and the relative self-position that is supplied from the relative self-position estimation unit 132 by using the relative position tree. Examples of the position relationship of the maps include a map state, a relationship between a map origin and a self-position identification origin, a relationship between map origins, and the like.

The map management unit 138 manages the relationship between the maps by updating a link that is linked to a map origin in the relative position tree. The map management unit 138 loads map information capable of estimating an absolute self-position to the relative position tree, and performs retention and update of a relative position between map origins. Information of the relative position tree is output to the map analysis unit 151, and can be used to analyze information described in a map and a relative self-position. The map management unit 138 expands a map coordinate system of the map by the map analysis unit 151 on the basis of the relative position tree.

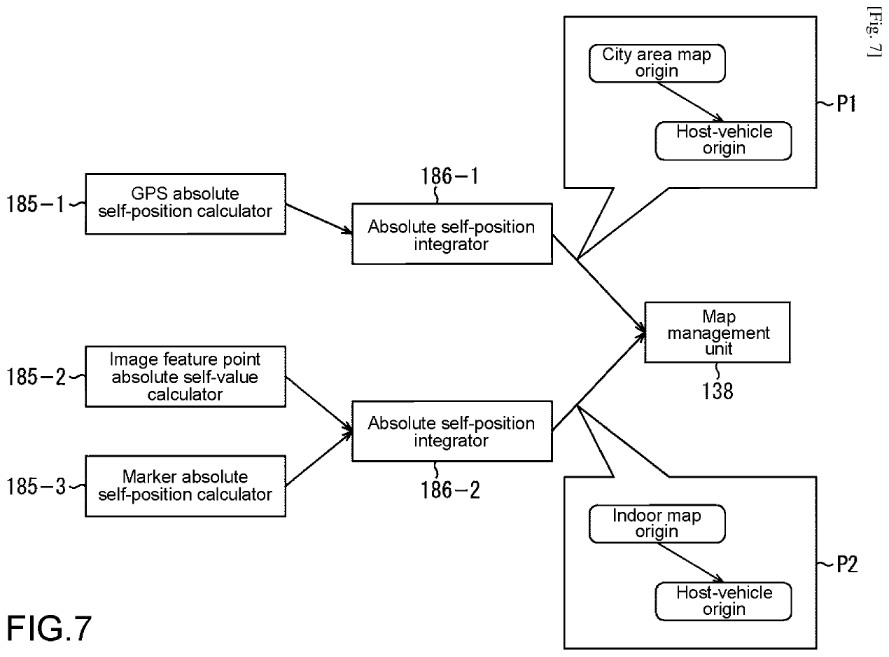

FIG. 7 is a view illustrating an example of an update process of the relative position tree in a case where a city map and an indoor map of a building exist.

A GPS absolute self-position calculator 185-1 calculates an absolute self-position on a map coordinate system of the city map. An image feature point absolute self-position calculator 185-2 and a marker absolute self-position calculator 185-3 calculates an absolute self-position in a map coordinate system of the indoor map.

The GPS absolute self-position calculator 185-1 calculates the absolute self-position in the map coordinate system of the city map by using a GPS signal that calculates the map coordinate system of the city map. The GPS absolute self-position calculator 185-1 outputs the calculated absolute self-position to the absolute self-position integrator 186-1.

Calculated absolute self-positions are integrated by the absolute self-position integrator 186-1. The “absolute self-position in the map coordinate system of the city map” is also a “relative position of a host-vehicle origin with respect to a city map origin”.

As illustrated in a balloon P1, the absolute self-position integrator 186-1 outputs the “relative position of the host-vehicle origin with respect to the city map origin” to the map management unit 138.

A relative self-position (that is, a “relative position of the host-vehicle origin with respect to a self-position identification origin”) output from the relative self-position estimation unit 132 is supplied to the map management unit 138.

The map management unit 138 calculates a “relative position of the city map origin with respect to the self-position identification origin” by using the “relative position of the host-vehicle origin with respect to the city map origin” and the “relative position of the host-vehicle origin with respect to the self-position identification origin”. The map management unit 138 writes the calculated “relative position of the city map origin with respect to the self-position identification origin” in the relative position tree, and updates the relative position tree.

The map management unit 138 loads the city map information in a state in which the relative position tree is updated by the city map origin.

The image feature point absolute self-position calculator 185-2 calculates an absolute self-position in the map coordinate system of the indoor map by using image feature point extracted from an image, and outputs the calculated absolute self-position to the absolute self-position integrator 186-2.

The marker absolute self-position calculator 185-3 calculates an absolute self-position in the map coordinate system of the indoor map by using a marker recognized from the image, and outputs the calculated absolute self-position to the absolute self-position integrator 186-2.

Calculated absolute self-positions are integrated by the absolute self-position integrator 186-2. The “absolute self-position in the map coordinate system of the indoor map” is also a “relative position of the host-vehicle origin with respect to an indoor map origin”.

As illustrated in a balloon P2, the absolute self-position integrator 186-2 outputs the “relative position of the host-vehicle origin with respect to the indoor map origin” to the map management unit 138.

The map management unit 138 calculates a “relative position of the indoor map origin with respect to the self-position identification origin” by using the “relative position of the host-vehicle origin with respect to the indoor map origin” and the “relative position of the host-vehicle origin with respect to the self-position identification origin”. The map management unit 138 writes the calculated “relative position of the indoor map origin with respect to the self-position identification origin” in the relative position tree, and updates the relative position tree.

In addition, the map management unit 138 loads indoor map information in a state in which the relative position tree is updated by the indoor map origin.

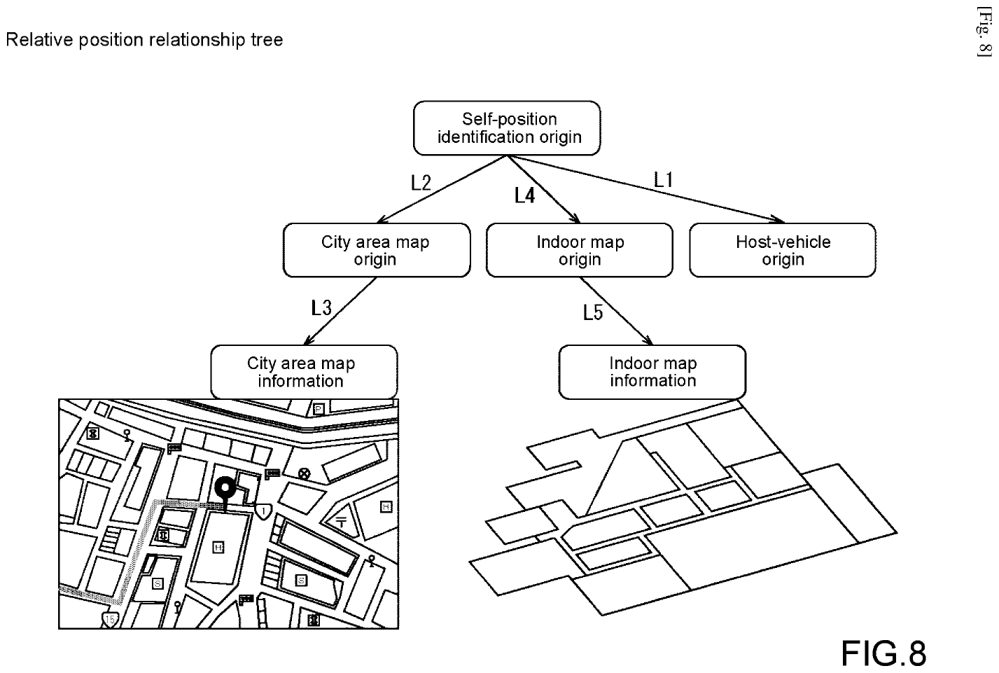

FIG. 8 illustrates an example of the relative position tree that is updated by the update process in FIG. 7.

In a relative position tree illustrated in FIG. 8, as a slave node of the self-position identification origin, the host-vehicle origin is linked by a link L1, and as a slave node of the self-position identification origin, the city map origin is linked by a link L2. Then, the city map information is linked by a link L3 as a slave node of the city map origin in the relative position tree, and is loaded.

In addition as a slave node of the self-position identification origin, the indoor map origin is linked by a link L4. Then, the indoor map information is linked by a link L5 as a slave node of the indoor map origin in the relative position tree, and is loaded.

As described above, the map origin can be set as the slave node of the self-position identification origin or another map origin, and thus a plurality of map origins can be linked to one tree.

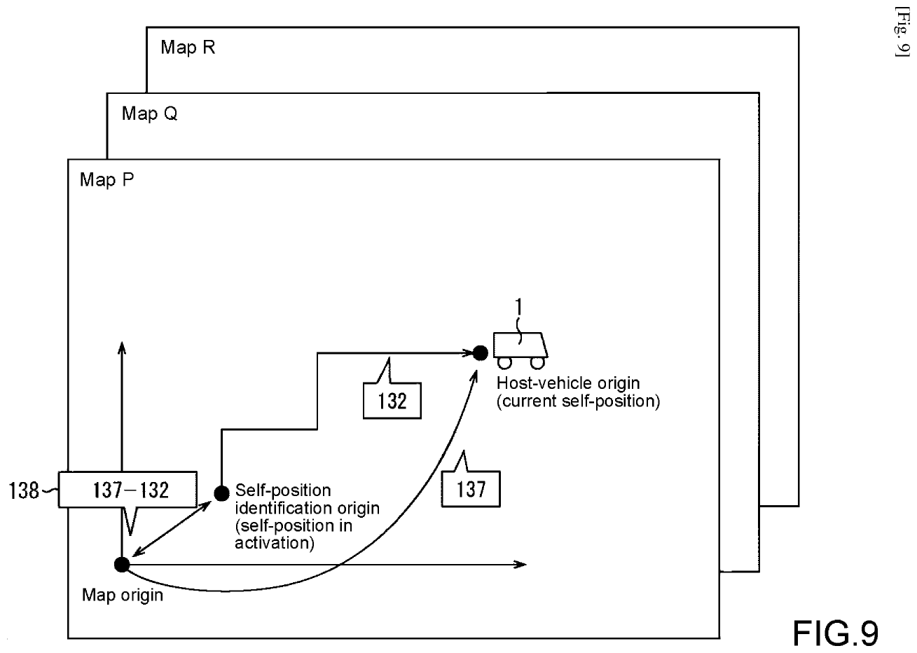

FIG. 9 is a view illustrating an example of position information in a plurality of maps.

In FIG. 9, a coordinate system of a map P is illustrated. The map P, a map Q, and a map R respectively include coordinate systems different from each other.

The host-vehicle origin is a current self-position of the mobile apparatus 1. The self-position identification origin is a self-position at the time of activating the mobile apparatus 1.

The relative position of the host-vehicle origin with respect to the self-position identification origin is obtained by the relative self-position estimation unit 132. The relative position of the host-vehicle origin with respect to the self-position identification origin does not vary even in the map Q or the map R.

The relative position of the host-vehicle origin with respect to the map origin is obtained by the absolute self-position estimation unit 137. However, in the map P, the map Q, and the map R, a position of the map origin is different, and thus the relative position of the host-vehicle origin with respect to the map origin is different in the map P, the map Q, and the map R.

Here, with respect to the map P, the map Q, and the map R, the map management unit 138 obtains the relative position of the self-position identification origin with respect to the map origin on the basis of the relative position of the host-vehicle origin with respect to the map origin, and the relative position of the host-vehicle origin with respect to the map origin. The relative position of the host-vehicle origin with respect to the map origin is obtained by the absolute self-position estimation unit 137. The relative position of the host-vehicle origin with respect to the self-position identification origin is obtained by the relative self-position estimation unit 132.

In the map management unit 138, a relative position of the self-position identification origin with respect to a map origin of the map P, a relative position of the self-position identification origin with respect to a map origin of the map Q, and a relative position of the self-position identification origin with respect to a map origin of the map R can be obtained. The relative positions of the self-position identification origin with respect to the map origins of the respective maps correspond to the link L2 and the link L4 in FIG. 8.

According to this, it is possible to add the map origins of the map P, the map Q, and the map R to the relative position tree.

### 4. Comparison Between Related Art and Present Technology in Case of Using Plurality of Maps

For comparison with the present technology, description will be given of a method in the related art by using an example in which a mobile apparatus enters a private land from a city area.

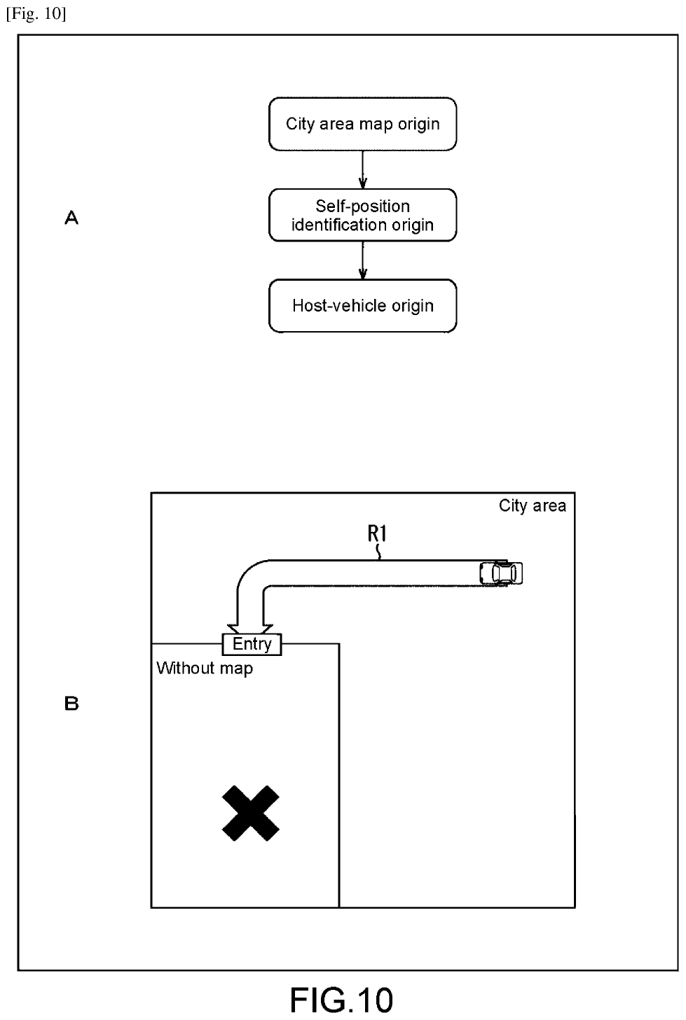

FIG. 10 is a view illustrating an example of a relative position tree and a movement route of the mobile apparatus of the related art in the city area.

A of FIG. 10 illustrates a relative position tree of a city area map in the related art.

As illustrated in A of FIG. 10, in the relative position tree of the city area map in the related art, a city area map origin is set as a master node, and the city area map origin and a self-position identification origin are linked by a link. In addition, the self-position identification origin is set as a master node, and the self-position identification origin and a host-vehicle origin are linked by a link.

B of FIG. 10 illustrates a city area map that is presented to an occupant in a method of the related art.

In B of FIG. 10, an outline arrow R1 indicates a travel route that is planned by the relative position tree of the city area.

In the related art, only one kind of map can be dealt with, and thus a portion corresponding to a private land on the city area map is presented in a state in which a map is absent as illustrated in B of FIG. 10. According to this, in the method of the related art, a travel route (arrow R1) can be presented only on the city area map.

In the method of the related art, as described above, it is difficult to simultaneously deal with a plurality of maps, and thus when travelling in the city area, it is difficult to link a private land map to the relative position tree in A of FIG. 10, and travelling is performed with only the city area map illustrated in B of FIG. 10.

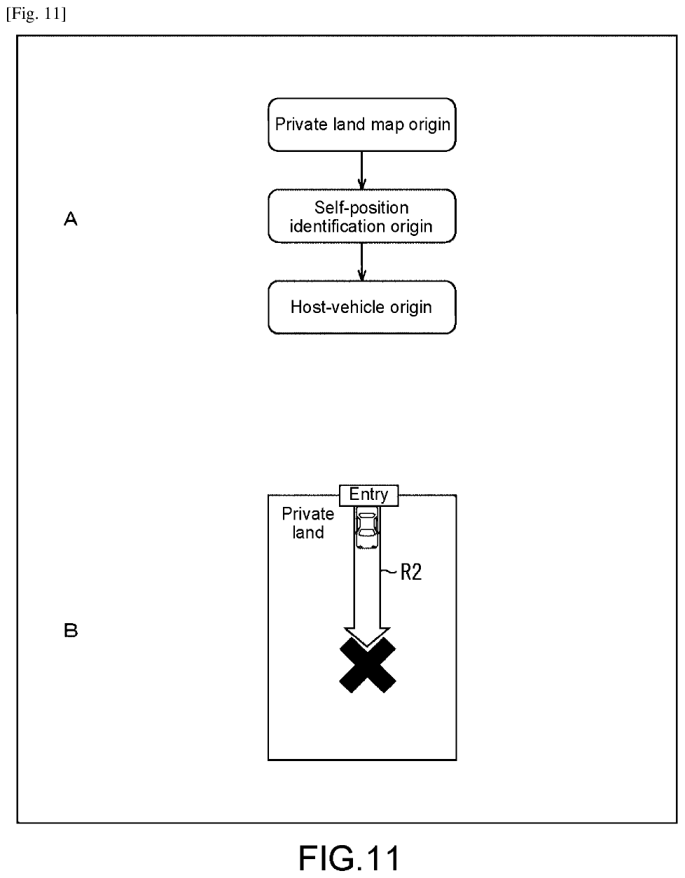

FIG. 11 is a view illustrating an example of a relative position tree and a movement route of the mobile apparatus of the related art in a private land.

A of FIG. 11 illustrates a relative position tree of a private land map in the related art.

As illustrated in A of FIG. 11, in the relative position tree of the private land map in the related art, a private land map origin is set as a master node, and the private land map origin and the self-position identification origin are linked by a link. In addition, the self-position identification origin is set as a master node, and the self-position identification origin and the host-vehicle origin are linked by a link.

B of FIG. 11 illustrates a private land map that is presented to an occupant by a method of the related art.

In B of FIG. 11, an outline arrow R2 indicates a travel route that is planned in the relative position tree of the private land.

In the related art, only one kind of map can be dealt with, and thus as illustrated in B of FIG. 11, only the private land map is presented. Accordingly, in the method of the related art, only a travel route (arrow R2) in the private land is presented, and it is difficult to know a travel route in the city area map before entering the private land.

When entering the private land, as the private land map origin illustrated in A of FIG. 11 is used as a master node of the self-position identification origin, and thus it is difficult to link the city area map origin illustrated in A of FIG. 10, and travelling is performed with only the private land map illustrated in B of FIG. 11.

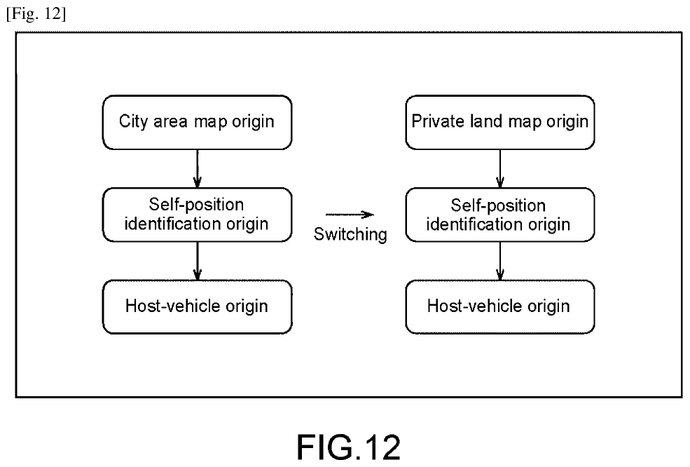

According to this, in the method of the related art, switching of map origins occurs as illustrated in FIG. 12, and thus a process of transitioning a map that can be used in planning of a travel route from the city area map to the private land map is complicated.

FIG. 12 is a view illustrating an example of switching of map coordinate systems in the related art.

In FIG. 12, a relative position tree of the city area map, and a relative position tree of the private land map are illustrated in this order from the left to the right. In the relative position tree of the city area map, a master node is the city area map origin, and thus it is difficult to link the relative position tree of the private land in which a master node is the private land map origin.

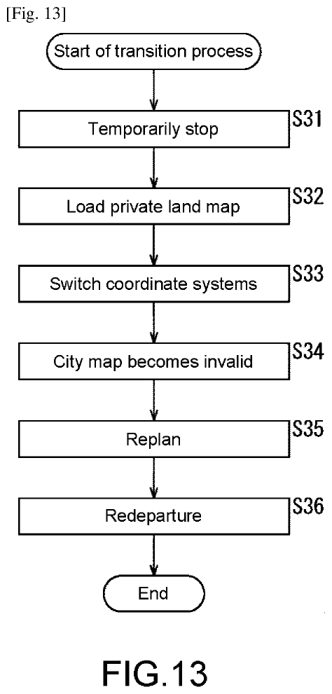

Here, as indicated by an arrow, the relative position tree of the city area map can be switched to the relative position tree of the private land map. Accordingly, when the relative position tree of the private land map is changed, in a travel route that is generated in the relative position tree of the city area map, it is difficult to analyze a position relationship, and thus it is necessary to temporarily replan a travel route. Accordingly, in the mobile apparatus of the related art, as illustrated in FIG. 13, there is a concern that temporary stopping or the like may occur during travelling.

FIG. 13 is a flowchart describing a map transition process in the related art.

The mobile apparatus in the related art is travelling in the city area along the travel route (arrow R1) on the city area map.

In step S31, travelling is temporarily stopped.

In step S32, the private land map is loaded.

In step S33, a map coordinate system in the mobile apparatus is switched from a map coordinate system of the city area to a map coordinate system of the private land as illustrated in FIG. 12.

In step S34, the city area map becomes invalid. Accordingly, the travel plan that is generated in the relative position tree of the city area map becomes invalid.

In step S35, replanning of the travel route (arrow R2) is performed on the basis of the relative position tree of the private land map.

In step S36, the mobile apparatus departs again on the basis of the replanned travel route.

As described above, in the method of the related art, switching of map origins occurs, and thus a process of transitioning a map used in planning of a travel route from the city area map to the private land map becomes complicated.

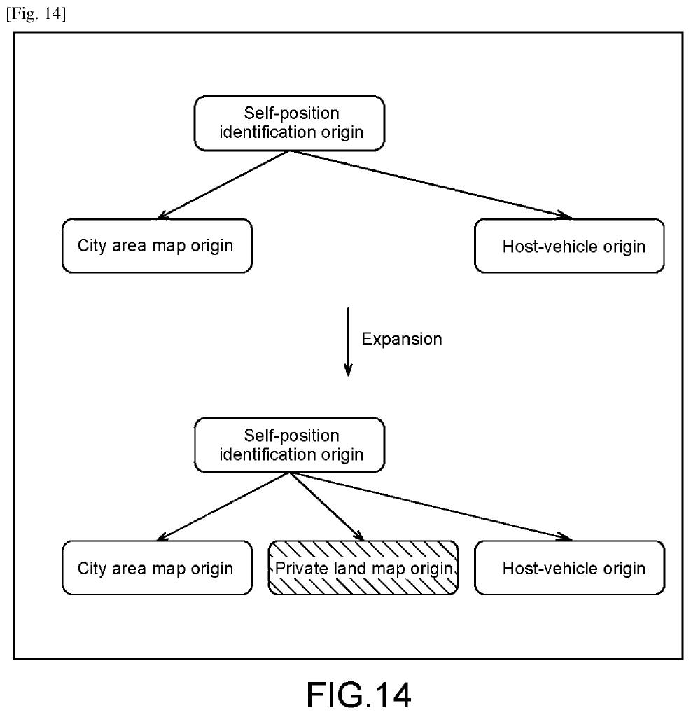

FIG. 14 is a view illustrating an expansion example of a map coordinate system according to the present technology.

In FIG. 14, a relative position tree of the city area map and an expanded relative position tree according to the present technology are illustrated in this order from an upper side.

In the relative position tree of the city area map, the self-position identification origin is a master node, and the city area map origin and the host-vehicle origin are linked to the self-position identification origin by a link.

The map management unit 138 adds a hatched private land map origin to the relative position tree of the city area map on the basis of a relative position of the host-vehicle origin with respect to the self-position identification origin.

That is, in the expanded relative position tree, the private land map origin is added while retaining the relative position tree of the city area map.

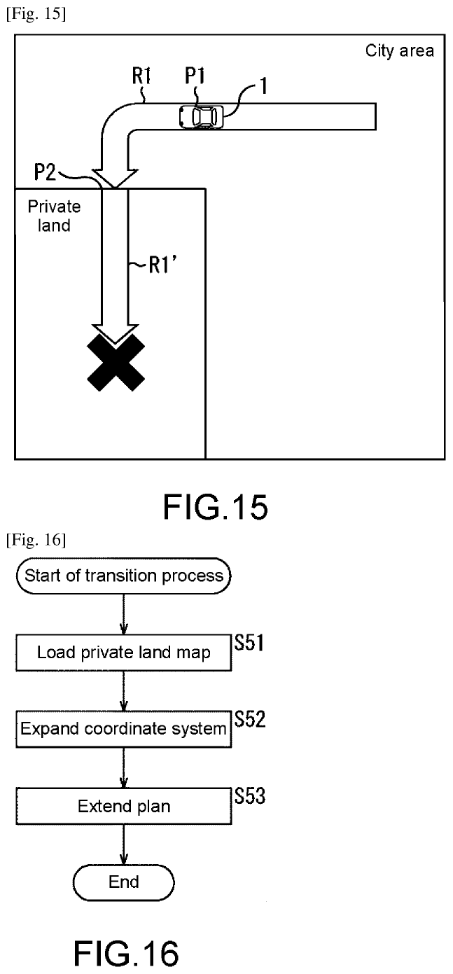

FIG. 15 is a view illustrating an example of an expanded map.

FIG. 15 illustrates the city area map that is presented to an occupant as an expanded map and includes the private land map. In addition, an outline arrow R1 indicates a travel route that is planned on the basis of the relative position tree of the city area. An outline arrow R1′ indicates a travel route that is planned on the basis of the expanded relative position tree.

At a position P1 illustrated on the travel route (arrow R1) planned on the relative position tree of the city area, the private land map is loaded, and thus the relative position tree is expanded.

In addition, at the position P1, a position relationship of the travel route (arrow R1) planned in the relative position tree of the city area is acquired on the basis of the expanded relative position tree in FIG. 14. As illustrated in FIG. 15, the private land map is presented to a portion corresponding to the private land on the city area map.

At the position P1, in the case of performing planning on the basis of the expanded relative position tree, the city area map does not become invalid. According to this, the travel route (arrow R1) can be extended to the travel route (arrow R1′) from a position P2 of a boundary between the city area and the private land toward a destination (X mark) in the private land. According to this, it is possible to expect smooth travelling of the mobile apparatus 1.

FIG. 16 is a flowchart describing a map transition process by the mobile apparatus 1.

The mobile apparatus 1 is travelling in the city area along the travel route (arrow R1) on the city area map.

As illustrated in FIG. 13, the map management unit 138 adds a map coordinate system of the private land to a map coordinate system of the city area to update the relative position tree.

In step S51, the map management unit 138 loads the private land map on the basis of the relative position tree, and performs retention and update of a relative position between map origins. Information of the relative position tree is output to the map analysis unit 151.

In step S52, the map analysis unit 151 expands the map coordinate system on the basis of the updated relative position tree. The map analysis unit 151 analyzes the expanded map coordinate system.

In step S53, the planning unit 134 extends a plan of the travel route (arrow R1′) on the basis of analysis of the expanded map coordinate system.

As described above, in a case where map information increases, the relative position tree is expanded. According to this, it is possible to extend the travel route (arrow R1′) with respect to the travel route (arrow R1) before expansion.

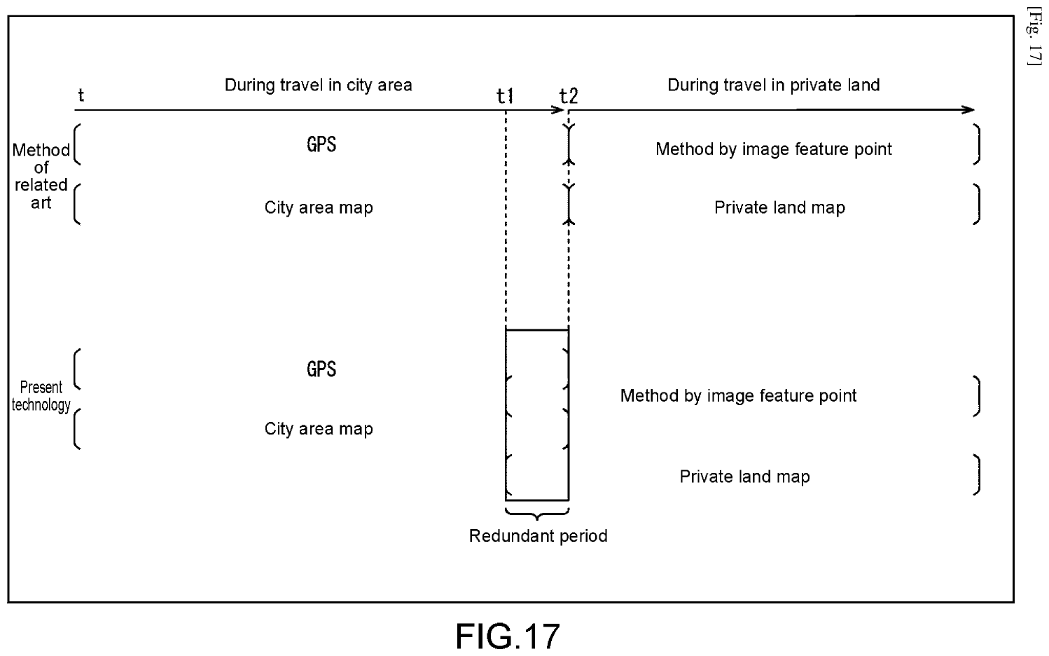

FIG. 17 is a view illustrating comparison between the related art and the present technology along a time axis.

In a mobile apparatus, a self-position in the city area map supplied from the GPS absolute self-position calculator 185-1 is calculated during travel in the city area. In the mobile apparatus, a self-position in the private land map supplied from the image feature point absolute self-position calculator 185-2 is calculated during travel in the private land.

In the related method, at a time t2 of reaching a boundary between the city area and the private land, the mobile apparatus temporarily stops as described in FIG. 13, loads the private land map, and switches the map coordinate system of the mobile apparatus from the map coordinate system of the city area to the map coordinate system of the private land.

In contrast, in the present technology, at a time t1 (position P1 in FIG. 15) during travel in the city area, the mobile apparatus 1 loads the private land map, expands the relative position tree, and extends the travel route. At the time t2 (position P2 in FIG. 15) of reaching the boundary between the city area and the private land, the mobile apparatus 1 travels by using a travel route that is planned on the basis of the relative position tree of the private land map.

That is, a period between the time t1 and the time t2 is a redundant period in which two maps including the city area map and the private land map are redundantly used, and it is possible to use the travel route that is extended on the basis of the expanded relative position tree as described above. In the redundant period, it is possible to use the relative position tree that is linked to both map origins, and thus it is possible to use the extended travel route.

According to this, even in a case where only the private land map is used at the time t2, and a period in which two maps are used is a temporary redundant period, the mobile apparatus 1 can perform smooth travel over a plurality of maps.

<Operation of Mobile Apparatus>

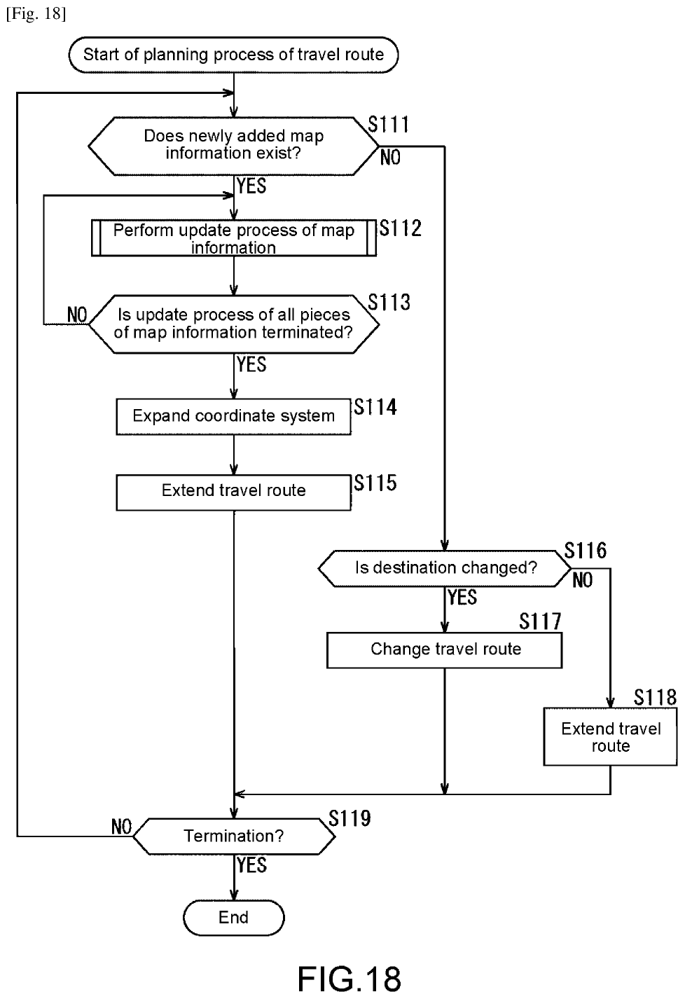

FIG. 18 is a flowchart describing a planning process of the travel route of the mobile apparatus 1.

For example, in the mobile apparatus 1, new map information is acquired at the time of purchasing a ticket, at a predetermined position, at a location spaced apart from a boundary between maps by a predetermined distance, and the like.

In step S111, the map management unit 138 determines whether or not newly added map information exists. In step S111, in a case where it is determined that the newly added map information exists, the process proceeds to step S112.

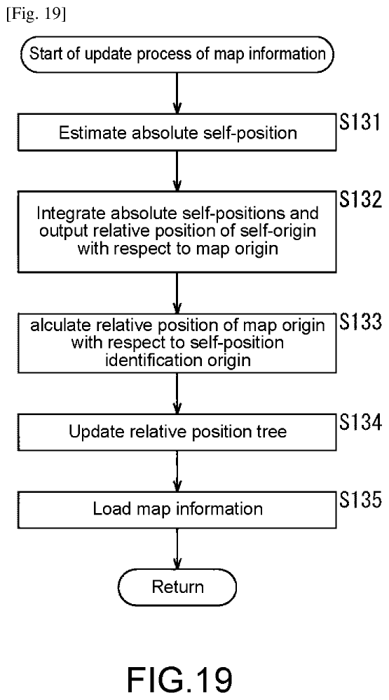

In step S112, the map management unit 138 performs an update process of map information. The update process of map information will be described later with reference to FIG. 19. A relative position of the map origin with respect to the self-position identification origin is calculated through the process in step S112, the relative position tree is updated, and map information is loaded.

In step S113, the map management unit 138 determines whether or not an update process of all pieces of map information for which update is necessary is terminated. In step S113, in a case where it is determined that the update process of all pieces of map information for which update is necessary is not terminated yet, the process returns to step S112, and the subsequent processes are repeated.

In step S113, in a case where it is determined that the update process of all pieces of map information for which update is necessary is terminated, the process proceeds to step S114.

In step S114, the map analysis unit 151 expands a map coordinate system of a map that is used on the basis of the relative position tree under control by the map management unit 138.

In step S115, the route planning unit 161 extends the travel route on the basis of the expanded map coordinate system. Then, the process proceeds to step S119.

In step S111, in a case where it is determined that newly added map information does not exist, the process proceeds to step S116.

In step S116, the route planning unit 161 determines whether or not to change a destination on the basis of information that is supplied from the situation analysis unit 133.

In step S116, in a case where it is determined that the destination is to be changed, the process proceeds to step S117.

In step S117, the route planning unit 161 changes the travel route on the basis of the changed destination. Then, the process proceeds to step S119.

In step S116, in a case where it is determined that the destination is not to be changed, the process proceeds to step S118.

In step S118, the route planning unit 161 extends the travel route. Then, the process proceeds to step S119.

In step S119, the route planning unit 161 determines whether or not to terminate the process.

In step S119, in a case where it is determined that the process is not to be terminated, the process returns to step S111, and the subsequent processes are repeated.

In step S119, in a case where it is determined that the process is to be terminated, the planning process of the travel route is terminated.

FIG. 19 is a flowchart describing the update process of map information in step S112 illustrated in FIG. 18.

In step S131, the absolute self-position calculators 185-1 to 185-n perform an estimation process of an absolute self-position. The estimation process of the absolute self-process is performed on the basis of information that is supplied from the data acquisition unit 102, the vehicle state detection unit 143, the vehicle exterior information detection unit 141, the situation recognition unit 153 of the situation analysis unit 133, and the like.

In step S132, the absolute self-position integrator 186 integrates outputs of a plurality of the absolute self-position calculators 185, and outputs an integrated absolute self-position, that is, a relative position of the self-origin with respect to the map origin to the map management unit 138.

In step S132, a relative self-position supplied from the relative self-position estimation unit 132 is also integrated.

In step S133, the map management unit 138 calculates a relative position of the map origin with respect to the self-position identification origin.

In step S134, the map management unit 138 updates the relative position tree on the basis of the relative position of the map origin with respect to the self-position identification origin.

In step S135, the map management unit 138 loads map information capable of estimating the absolute self-position to the relative position tree, and performs retention and update of the relative position between map origins. The updated relative position tree is output to the map analysis unit 151.

Note that, when updating the relative position tree in step S134, as illustrated in B of FIG. 5, it is possible to add the map origin as a slave node of another map origin.

For example, when an absolute self-position in the map-3 origin is estimated, an absolute self-position in the map-1 origin has been estimated, a relative position of the map-3 origin with respect to the map-1 origin can be calculated. Accordingly, it is possible to retain the relative position of the map-3 origin with respect to the map-1 origin in the relative position tree.

It is assumed that the mobile apparatus 1 is activated again, and is in a state in which the absolute self-position in each map origin cannot be estimated. At this time, the relative position of the map-3 origin with respect to the map-1 origin is retained already, when an absolute self-position of any one of the map-1 origin and the map-3 origin is acquired, an absolute self-position of the other side can be calculated.

### 5. Effects by Present Technology

When applying the present technology, maps described in a plurality of map coordinate systems are added to the same relative position tree, and a position relationship can be acquired.

According to this, it is possible to simultaneously deal with pieces of information of the plurality of maps. For example, it is possible to link maps of a city area, a private land, a parking lot, and indoors, and thus it is possible to perform planning of a travel route over maps. According to this, the mobile apparatus can smoothly travel over a plurality of maps.

According to the present technology, estimation processes of different absolute self-positions are executed in parallel, and thus even in a case where a map coordinate system (an estimation method of an absolute self-position) capable of being used moves to another location, the mobile apparatus can perform smooth travel.

For example, it is difficult to use an estimation method of an absolute self-position by a GPS signal at indoors, and it is difficult to use an estimation method of an absolute self-position by a marker or an image feature amount in a city area. However, according to the present technology, it is possible to link an indoor map and a city area map.

In addition, according to the present technology, it is possible to integrate a result of an estimation process of a plurality of absolute self-positions in the same map coordinate system, and a relative self-position, and thus it is possible to improve robustness and accuracy.

For example, it is possible to perform integration of GPS and map matching (NDT) of LiDAR at outdoors, and it is possible to perform integration of an estimation process of an absolute self-position by a marker and map matching of an image feature point, and the like at indoors.

In addition, according to the present technology, it is possible to simultaneously deal with a plurality of maps of a city area, a private land, and the like, and thus it is possible to plan a travel route with higher accuracy.

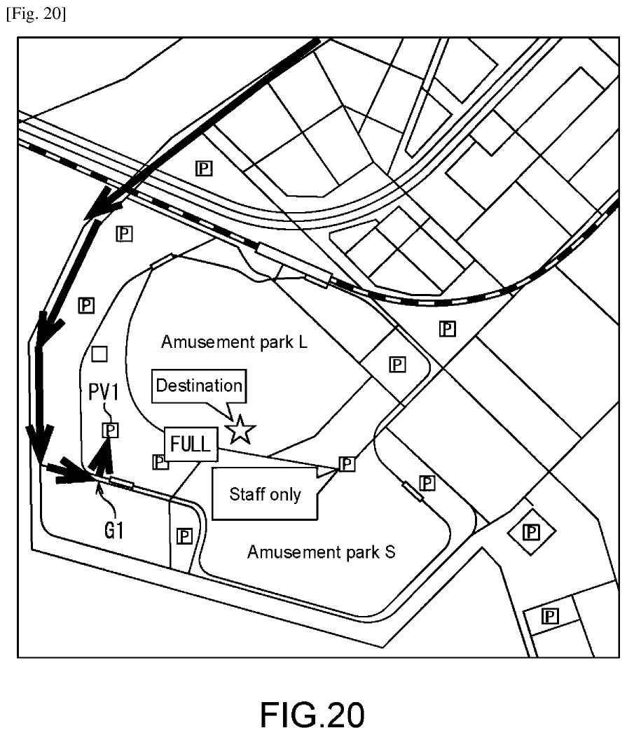

FIG. 20 to FIG. 23 are views illustrating an example of the effects by the present technology.

FIG. 20 to FIG. 23 illustrate maps on which a travel route in a city area map and a private land map which are linked by the present technology is shown.

In the maps in FIG. 20 to FIG. 23, a private land map and a city area map nearby the private land map are illustrated. In a private land, an amusement park L and an amusement park S are arranged, and a plurality of parking lots P is provided at the periphery of the amusement parks. A star mark indicates a destination.

A rectangular of P indicates a parking lot. In a case where an empty space is not present in the parking lot, a mark “FULL” is attached to the rectangular of P. Characters of “park here” are attached to a parking lot that can be determined by a travel plan. Among rectangles of P, in the case of a staff only parking lot, characters indicating “staff only” are attached thereto. G indicates an entrance gate through which the mobile apparatus 1 enters a private land. A bold line arrow indicates a planned travel route. A plurality of the bold line arrows represents that respective travel routes are sequentially planned.

In FIG. 20, a first travel route is illustrated. The first travel route is a travel route that is planned so that the mobile apparatus 1 enters the private land (amusement park L) from an entrance gate G1 that is closest to an occupant's destination, selects an empty parking lot PV1 that is closest to the occupant's destination, and parks in the parking lot PV1.

The first travel route configured as described above is planned during travel of the mobile apparatus 1 in the city area, and thus the mobile apparatus 1 can smoothly travel.

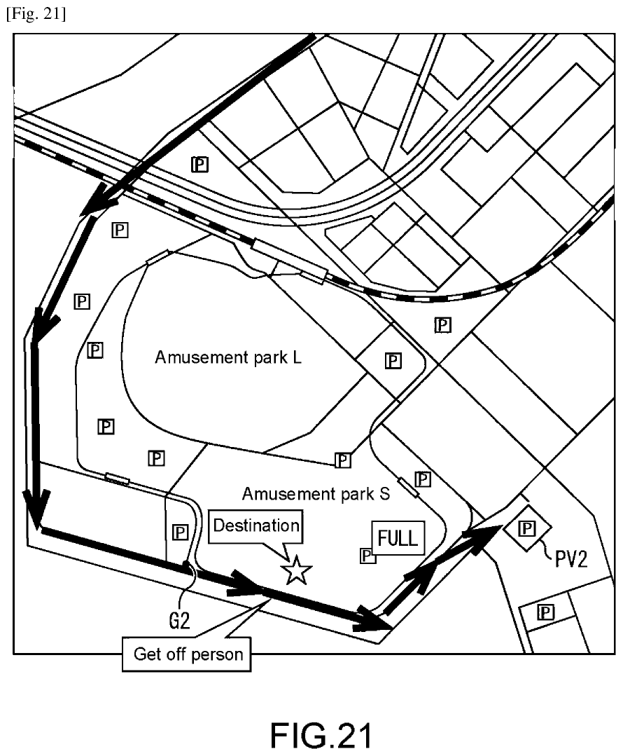

In FIG. 21, a second travel route is illustrated. The second travel route is a travel route that is planned so that the mobile apparatus 1 enters the private land from an entrance gate G2 that is closest to an occupant's destination, allows the occupant to get off, moves to an empty parking lot PV2 that is closest through automatic drive, and parks in the parking lot PV2.

The second travel route configured as described above is planned during travel of the mobile apparatus 1 in the city area, and thus the mobile apparatus 1 can smoothly travel.

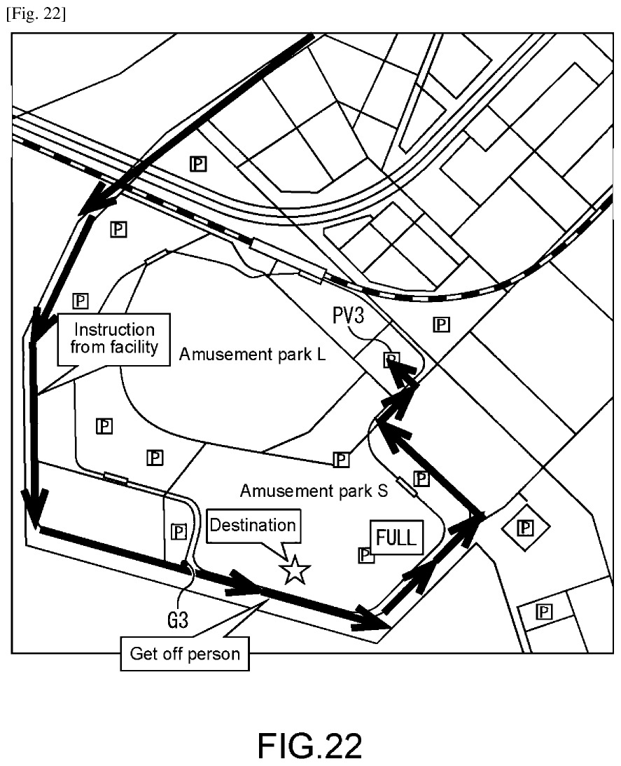

In FIG. 22, a third travel route is illustrated. The third travel route is a travel route in which parking is performed in the order of an entrance gate G3 closest to an occupant's destination, a travel route, and a parking lot PV3 which are transmitted from a facility side over communication in a case where the facility side of the private land manages parking lot information for congestion mitigation.

After the third travel route configured as described above is planned during travel of the mobile apparatus 1 in the city area, a travel route planned on the facility side is received, and thus the mobile apparatus 1 can smoothly travel.

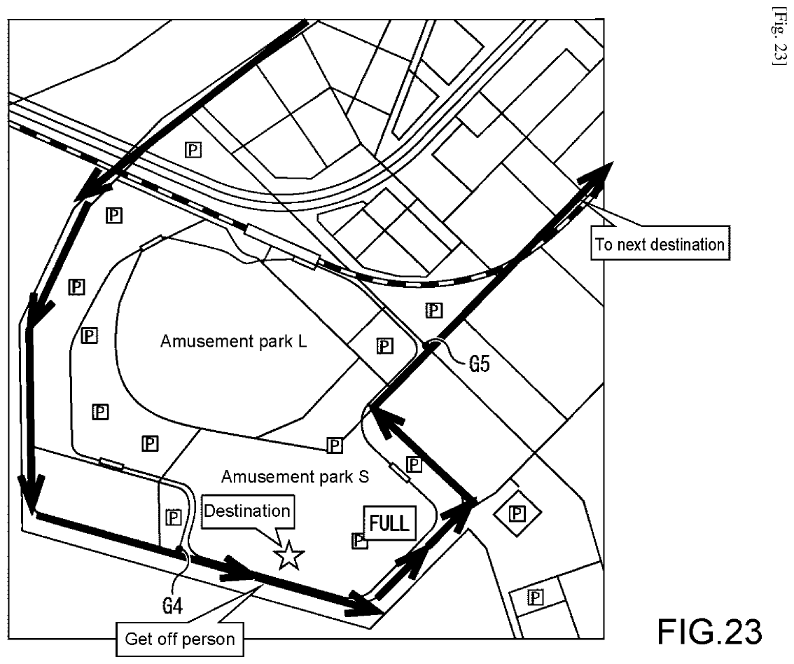

In FIG. 23, a fourth travel route is illustrated. The fourth travel route is a travel route that is planned in a case where the mobile apparatus 1 does not park in car sharing and the like. The fourth travel route is a travel route that is planned so that the mobile apparatus 1 enters the private land from an entrance gate G4 that is closest to an occupant's destination, allows an occupant to get off, and gets out from an exit gate G5 that is optimal to move toward a next destination in the city area map.

The fourth travel route configured as described above is planned during travel of the mobile apparatus 1 in the city area, and thus the mobile apparatus 1 can smoothly travel.

Note that, the effects described in this specification are illustrative only and are not limited, and other effects may be exhibited.

### 6. Mobile Body Control System

FIG. 24 is a view illustrating a configuration example of a mobile body control system to which the present technology is applied.

A mobile body control system 201 in FIG. 24 includes a mobile apparatus 211 and a server 212.

The mobile apparatus 211 and the server 212 are connected to each other by wireless communication or the like.

For example, the mobile apparatus 211 has a configuration in which at least the self-position estimation unit 136 and the map management unit 138 are excluded from the configuration of the mobile apparatus 1 illustrated in FIG. 6.

The server 212 includes at least the self-position estimation unit 136 and the map management unit 138 illustrated in FIG. 6.

The mobile apparatus 211 transmits detection information of sensors corresponding to a plurality of self-position calculators, for example, various sensors such as a camera to the server 212 through wireless communication. The mobile apparatus 211 receives information of a relative position tree which is supplied from the server 212. The mobile apparatus 211 performs replanning of a travel route on the basis of the relative position tree that is received, and the mobile apparatus 211 travels on the basis of the travel route.

The server 212 estimates position information of the mobile apparatus 211 in a plurality of pieces of map information by using the sensor detection information that is supplied from the mobile apparatus 211, and performs an update process of the relative position tree. The server 212 transmits the information of the update relative position tree to the mobile apparatus 211.

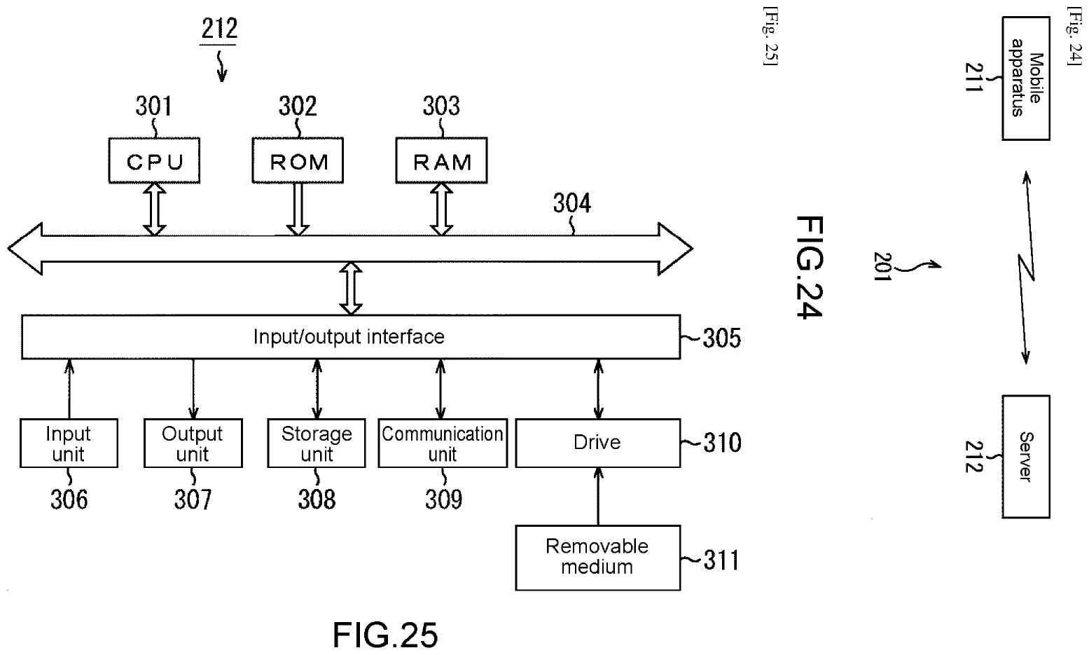

FIG. 25 is a block diagram illustrating a configuration example of hardware of the server 212.

In a computer, a central processing unit (CPU) 301, a read only memory (ROM) 302, and a random access memory (RAM) 303 are connected to each other by a bus 304.

An input/output interface 305 is also connected to the bus 304. An input unit 306, an output unit 307, a storage unit 308, a communication unit 309, and a drive 310 are connected to the input/output interface 305.

The input unit 306 is constituted by a keyboard, a mouse, a microphone, or the like.

The output unit 307 is constituted by a display, a speaker, or the like. The storage unit 308 is constituted by a hard disk, a nonvolatile memory, or the like. The communication unit 309 is constituted by a network interface, or the like. The drive 310 drives a removable medium 311 such as a magnetic disk, an optical disc, a magneto-optical disc, and a semiconductor memory.

In the computer configured as described above, the CPU 301 loads a program that is stored, for example, in the storage unit 308 to the RAM 303 through the input/output interface 305 and the bus 304, and executes the program. According to this, a functional block including at least the self-position estimation unit 136 and the map management unit 138 illustrated in FIG. 6 are constructed, and a series of processes are performed.

### 7. Others

The series of processes can be executed by hardware or by software. In the case of executing the series of processes by software, a program that constitutes the software is installed in a computer. Here, examples of the computer include a computer provided with exclusive hardware, a general-purpose pc capable of executing various functions by installing various programs, and the like.

The program that is installed is provided in a state of being recorded on the removable medium 311 that is illustrated in FIG. 25 and is constituted by an optical disc (compact disc-read only memory (CD-ROM), a digital versatile disc (DVD), or the like) or a semiconductor memory. In addition, the program may be provided through a wired or wireless transmission medium such as a local area network, the Internet, and digital satellite broadcasting. The program may be installed in the ROM 302 or the storage unit 308 in advance.

Note that, the program that is executed by the computer may be a program in which processes are performed on a time-series basis according to the procedure described in this specification, or may be a program in which processes are performed in parallel or at a necessary timing such as when a call is made.

In addition, in this specification, the systems represent an assembly of a plurality of constituent elements (devices, modules (parts), and the like), and it does not matter whether or not all of the constituent elements exist in the same housing. Accordingly, a plurality of devices which is accommodated in individual housings and are connected through a network, and one device in which a plurality of modules is accommodated in one housing are systems.

Note that, the effects described in this specification are illustrative only and are not limited, and other effects may exist.

An embodiment of the present technology is not limited to the above-described embodiment, and various modifications can be made in a range not departing from the gist of the present technology.

For example, the present technology can employ a cloud computing configuration in which one function is shared by a plurality of devices and is processed in cooperation through a network.

In addition, the respective steps described in the flowcharts can be executed in a state of being shared by a plurality of devices in addition to execution by one device.

In addition, in a case where a plurality of processes is included in one step, the plurality of processes included in one step can be executed in a state of being shared by a plurality of devices in addition to execution by one device.

<Combination Example of Configurations>

The present technology can employ the following configurations.

(1) An information processing apparatus, including:

a processor in communication with a memory configured to store instructions that, when executed by the processor, cause the processor to:

obtain a first relative position of a mobile body with respect to a self-position identification origin that is a movement initiation position of the mobile body; and

update relative position relationship information indicating a second relative position of each of a plurality of coordinate origins with respect to the self-position identification origin, wherein each of the plurality of coordinate origins is associated with a different predetermined coordinate system, on a basis of, for each coordinate origin of the plurality of coordinate origins:

a third relative position of the mobile body with respect to the coordinate origin; and

the first relative position of the mobile body with respect to the self-position identification origin.

(2) The information processing apparatus according to (1), wherein the instructions are further configured to cause the processor to:

calculate a plurality of absolute positions of the mobile body; and

integrate the plurality of absolute positions of the mobile body to obtain, for a coordinate origin of the plurality of coordinate origins, the third relative position of the mobile body with respect to the coordinate origin.

(3) The information processing apparatus according to (2), wherein the instructions are further configured to cause the processor to:

integrate a plurality of relative self-positions of the mobile body in the coordinate system to obtain, for a coordinate origin of the plurality of coordinate origins, the third relative position of the mobile body with respect to the coordinate origin.

(4) The information processing apparatus according to (2), wherein:

each of the plurality of absolute positions is associated with different coordinate systems; or

each of the plurality of absolute positions is calculated using a different technique; or

both.

(5) The information processing apparatus according to any one of (1) to (4), wherein the instructions are further configured to cause the processor to:

load map information corresponding to a predetermined coordinate system of the plurality of predetermined coordinate systems on a basis of the updated relative position relationship information.

(6) The information processing apparatus according to (5), wherein the instructions are further configured to cause the processor to:

expand a coordinate system of map information in use by using the predetermined coordinate system to which the loaded map information corresponds.

(7) The information processing apparatus according to (5), wherein loading comprises loading the map information of a private land.

(8) The information processing apparatus according to any one of (1) to (7), wherein the instructions are further configured to cause the processor to:

add a coordinate origin of the plurality of coordinate origins to the self-position identification origin that is a master node or another coordinate origin that is a slave node to update the relative position relationship information.

(9) The information processing apparatus according to any one of (1) to (7), wherein the instructions are further configured to cause the processor to:

replan a travel route of the mobile body by using a coordinate system that is expanded on a basis of the updated relative position relationship information.

(10) The information processing apparatus according to (1), wherein the instructions are further configured to cause the processor to:

obtain, for each coordinate origin of the plurality of coordinate origins, the third relative position of the current self-position of the mobile body with respect to the coordinate origin.

(11) An information processing method, including:

obtaining a first relative position of a mobile body with respect to a self-position identification origin that is a movement initiation position of the mobile body; and

updating relative position relationship information indicating a second relative position of each of a plurality of coordinate origins with respect to a plurality of the self-position identification origin, wherein each of the plurality of coordinate origins is associated with a different predetermined coordinate system, on a basis of, for each coordinate origin of the plurality of coordinate origins:

a third relative position of the mobile body with respect to the coordinate origin; and

the first relative position of the mobile body with respect to the self-position identification origin.

(12) The information processing method according to (11), further comprising:

calculating a plurality of absolute positions of the mobile body; and

integrating the plurality of absolute positions of the mobile body to obtain, for a coordinate origin of the plurality of coordinate origins, the third relative position of the mobile body with respect to the coordinate origin.

(13) The information processing method according to (11), further comprising:

loading map information corresponding to a predetermined coordinate system of the plurality of predetermined coordinate systems on a basis of the updated relative position relationship information.

(14) The information processing method according to (13), further comprising:

expanding a coordinate system of map information in use by using the predetermined coordinate system to which the loaded map information corresponds.

(15) The information processing method according to (13), wherein loading comprises loading the map information of a private land.

(16) The information processing method according to (11), further comprising:

adding a coordinate origin of the plurality of coordinate origins to the self-position identification origin that is a master node or another coordinate origin that is a slave node to update the relative position relationship information.

(17) The information processing method according to (11), further comprising:

replanning a travel route of the mobile body by using a coordinate system that is expanded on a basis of the updated relative position relationship information.

(18) The information processing method according to (11), further comprising:

obtaining, for each coordinate origin of the plurality of coordinate origins, the third relative position of the current self-position of the mobile body with respect to the coordinate origin.

(19) A program that causes a computer to function as:

a relative self-position estimation unit that obtains a first relative position of a mobile body with respect to a self-position identification origin that is a movement initiation position of the mobile body; and

a map management unit that updates relative position relationship information indicating a second relative position of each of a plurality of coordinate origins with respect to a plurality of the self-position identification origin, wherein each of the plurality of coordinate origins is associated with a different predetermined coordinate system, on a basis of, for each coordinate origin of the plurality of coordinate origins:

a third relative position of the mobile body with respect to the coordinate origin; and

the first relative position of the mobile body with respect to the self-position identification origin.

(20) A mobile body control system, including:

an information processing apparatus including,

a relative self-position estimation unit that obtains a first relative position of a mobile body with respect to a self-position identification origin that is a movement initiation position of the mobile body, and

a map management unit that updates relative position relationship information indicating a second relative position of each of a plurality of coordinate origins with respect to the self-position identification origin, wherein each of the plurality of coordinate origins is associated with a different predetermined coordinate system, on a basis of, for each coordinate origin of the plurality of coordinate origins:

a third relative position of the mobile body with respect to the coordinate origin; and

the first relative position of the mobile body with respect to the self-position identification origin; and

the mobile body including a movement control unit that controls movement by using a coordinate system that is expanded on a basis of the relative position relationship information.

### REFERENCE SIGNS LIST

1 Mobile apparatus
100 Vehicle control system
102 Data acquisition unit
103 Communication unit
107 Driving system control unit
108 Driving system
111 Storage unit
132 Relative self-position estimation unit
133 Situation analysis unit
136 Self-position estimation unit
137 Absolute self-position estimation unit
138 Map management unit
151 Map analysis unit
153 Situation recognition unit
154 Situation prediction unit
161 Route planning unit
162 Action planning unit
163 Operation planning unit
181 Relative self-position calculation unit
182-1 to 182-n Relative self-position calculator
183 Relative self-position integration unit
184 Absolute self-position calculation unit
185-1 to 185-n Absolute self-position calculator
186-1 and 186-2 Absolute self-position integrator

1. An information processing apparatus, comprising:
a processor in communication with a memory configured to store instructions that, when executed by the processor, cause the processor to:
obtain a first relative position of a mobile body with respect to a self-position identification origin that is a movement initiation position of the mobile body; and
update relative position relationship information indicating a second relative position of each of a plurality of coordinate origins with respect to the self-position identification origin, wherein each of the plurality of coordinate origins is associated with a different predetermined coordinate system, on a basis of, for each coordinate origin of the plurality of coordinate origins:
a third relative position of the mobile body with respect to the coordinate origin; and
the first relative position of the mobile body with respect to the self-position identification origin.

2. The information processing apparatus according to claim 1, wherein the instructions are further configured to cause the processor to:
calculate a plurality of absolute positions of the mobile body; and
integrate the plurality of absolute positions of the mobile body to obtain, for a coordinate origin of the plurality of coordinate origins, the third relative position of the mobile body with respect to the coordinate origin.

3. The information processing apparatus according to claim 2, wherein the instructions are further configured to cause the processor to:
integrate a plurality of relative self-positions of the mobile body in the coordinate system to obtain, for a coordinate origin of the plurality of coordinate origins, the third relative position of the mobile body with respect to the coordinate origin.

4. The information processing apparatus according to claim 2, wherein:
each of the plurality of absolute positions is associated with different coordinate systems; or
each of the plurality of absolute positions is calculated using a different technique; or both.

5. The information processing apparatus according to claim 1, wherein the instructions are further configured to cause the processor to:
load map information corresponding to a predetermined coordinate system of the plurality of predetermined coordinate systems on a basis of the updated relative position relationship information.

6. The information processing apparatus according to claim 5, wherein the instructions are further configured to cause the processor to:
expand a coordinate system of map information in use by using the predetermined coordinate system to which the loaded map information corresponds.

7. The information processing apparatus according to claim 5, wherein loading comprises loading the map information of a private land.

8. The information processing apparatus according to claim 1, wherein the instructions are further configured to cause the processor to:
add a coordinate origin of the plurality of coordinate origins to the self-position identification origin that is a master node or another coordinate origin that is a slave node to update the relative position relationship information.

9. The information processing apparatus according to claim 1, wherein the instructions are further configured to cause the processor to:
replan a travel route of the mobile body by using a coordinate system that is expanded on a basis of the updated relative position relationship information.

10. The information processing apparatus according to claim 1, wherein the instructions are further configured to cause the processor to:
obtain, for each coordinate origin of the plurality of coordinate origins, the third relative position of the current self-position of the mobile body with respect to the coordinate origin.

11. An information processing method, comprising:
obtaining a first relative position of a mobile body with respect to a self-position identification origin that is a movement initiation position of the mobile body; and
updating relative position relationship information indicating a second relative position of each of a plurality of coordinate origins with respect to a plurality of the self-position identification origin, wherein each of the plurality of coordinate origins is associated with a different predetermined coordinate system, on a basis of, for each coordinate origin of the plurality of coordinate origins:
a third relative position of the mobile body with respect to the coordinate origin; and
the first relative position of the mobile body with respect to the self-position identification origin.

12. The information processing method according to claim 11, further comprising:
calculating a plurality of absolute positions of the mobile body; and
integrating the plurality of absolute positions of the mobile body to obtain, for a coordinate origin of the plurality of coordinate origins, the third relative position of the mobile body with respect to the coordinate origin.

13. The information processing method according to claim 11, further comprising:
loading map information corresponding to a predetermined coordinate system of the plurality of predetermined coordinate systems on a basis of the updated relative position relationship information.

14. The information processing method according to claim 13, further comprising:
expanding a coordinate system of map information in use by using the predetermined coordinate system to which the loaded map information corresponds.

15. The information processing method according to claim 13, wherein loading comprises loading the map information of a private land.

16. The information processing method according to claim 11, further comprising:
adding a coordinate origin of the plurality of coordinate origins to the self-position identification origin that is a master node or another coordinate origin that is a slave node to update the relative position relationship information.

17. The information processing method according to claim 11, further comprising:
replanning a travel route of the mobile body by using a coordinate system that is expanded on a basis of the updated relative position relationship information.

18. The information processing method according to claim 11, further comprising:
obtaining, for each coordinate origin of the plurality of coordinate origins, the third relative position of the current self-position of the mobile body with respect to the coordinate origin.

19. A program that causes a computer to function as:
a relative self-position estimation unit that obtains a first relative position of a mobile body with respect to a self-position identification origin that is a movement initiation position of the mobile body; and
a map management unit that updates relative position relationship information indicating a second relative position of each of a plurality of coordinate origins with respect to a plurality of the self-position identification origin, wherein each of the plurality of coordinate origins is associated with a different predetermined coordinate system, on a basis of, for each coordinate origin of the plurality of coordinate origins:
a third relative position of the mobile body with respect to the coordinate origin; and
the first relative position of the mobile body with respect to the self-position identification origin.

20. A mobile body control system, comprising:
an information processing apparatus including,
a relative self-position estimation unit that obtains a first relative position of a mobile body with respect to a self-position identification origin that is a movement initiation position of the mobile body, and a map management unit that updates relative position relationship information indicating a second relative position of each of a plurality of coordinate origins with respect to the self-position identification origin, wherein each of the plurality of coordinate origins is associated with a different predetermined coordinate system, on a basis of, for each coordinate origin of the plurality of coordinate origins:
a third relative position of the mobile body with respect to the coordinate origin; and
the first relative position of the mobile body with respect to the self-position identification origin; and
the mobile body including a movement control unit that controls movement by using a coordinate system that is expanded on a basis of the relative position relationship information.
